(19) United States
(12) Patent Application Publication
(10) Pub. No.: US 2025/0259588 A1
(43) Pub. Date: Aug. 14, 2025

(54) DISPLAY DEVICE, DISPLAY SYSTEM INCLUDING THE SAME, AND METHOD OF DRIVING THE DISPLAY DEVICE

(71) Applicant: SAMSUNG ELECTRONICS CO., LTD., Suwon-si (KR)

(72) Inventors: Heejin LEE, Suwon-si (KR); Sunkwon KIM, Suwon-si (KR); Yongil KWON, Suwon-si (KR); Seong-Young RYU, Suwon-si (KR); Uijong SONG, Suwon-si (KR); Hyunwook LIM, Suwon-si (KR)

(73) Assignee: SAMSUNG ELECTRONICS CO., LTD., Suwon-si (KR)

(21) Appl. No.: 18/890,096

(22) Filed: Sep. 19, 2024

(30) Foreign Application Priority Data
Feb. 13, 2024 (KR) 10-2024-0020310

(51) Int. Cl. G09G 3/20; G06F 3/01

(52) U.S. Cl. CPC G09G 3/2092; G06F 3/013; G09G 2310/0275; G09G 2310/0291; G09G 2310/0297; G09G 2320/02; G09G 2330/021; G09G 2340/0407; G09G 2354/00

(57) ABSTRACT

A display device may include: a gate driver configured to apply a plurality of gate signals to each of a plurality of gate lines; a source driver configured to generate a plurality of first data signals corresponding to each of a plurality of source lines; and an interpolation circuit configured to: receive the plurality of first data signals from the source driver; and provide a second data signal, obtained by interpolating a first data signal corresponding to a first source line among the plurality of source lines and a first data signal corresponding to a third source line among the plurality of source lines, to a second source line between the first source line and the third source line.

### CROSS-REFERENCE TO RELATED APPLICATION

This application claims priority to and the benefit of Korean Patent Application No. 10-2024-0020310 filed in the Korean Intellectual Property Office on Feb. 13, 2024, the entire contents of which are incorporated herein by reference.

### BACKGROUND

### 1. Field

The disclosure relates to a display device, a display system including the same, and a method of driving the display device.

### 2. Description of the Related Art

A micro display is a small-sized and high-resolution display that serve a component of augmented reality AR and virtual reality VR devices. The image emitted from the micro display may be transmitted to the user's eyes through an optical lens. The micro display may display an image rendered using Foveated Rendering.

The foveated rendering method is a technology for rendering an image so that an area in the image the user is staring at is displayed with high quality and other areas are displayed with low quality. Compared to the conventional rendering method where all areas of the image are displayed with high quality, the foveated rendering method processes images where some areas are displayed with low quality so that the power consumed by image processing processors such as graphic processing unit GPU can be reduced.

The micro display may include a plurality of pixels and a plurality of source amplifiers. A plurality of source amplifiers can provide data signals to pixels that represent regions of the foveated rendered image. A plurality of source amplifiers may provide data signals to pixels displaying areas of foveated rendered images. A plurality of source amplifiers may remain on-state to provide data signals to each of a pixel displaying a high-quality area with a foveated rendered image and a pixel displaying a low-quality area with a foveated rendered image.

### SUMMARY

One or more embodiments provide a display device capable of reducing power consumed by a source amplifier, a display system including the same, and a driving method of the display device. One or more embodiments provide a display device that improves the image quality of a low-quality area with a foveated rendered image, a display system including the same, and a method of driving the display device.

According to an aspect of the disclosure, a display device may include: a pixel array that may include: a plurality of pixels; a plurality of gate lines; and a plurality of source lines connected to the plurality of pixels. The display device may further include: a gate driver configured to apply a plurality of gate signals to each of the plurality of gate lines; a source driver configured to generate a plurality of first data signals corresponding to each of the plurality of source lines; and an interpolation circuit configured to: receive the plurality of first data signals from the source driver; and provide a second data signal, obtained by interpolating a first data signal corresponding to a first source line among the plurality of source lines and a first data signal corresponding to a third source line among the plurality of source lines, to a second source line between the first source line and the third source line.

According to an aspect of the disclosure, a display system may include: a host device providing an image signal may include a first area rendered with a first quality and a second area rendered with a second quality lower than the first quality; and a display device may include a plurality of pixels and a plurality of source lines respectively connected to the plurality of pixels, the display device being configured to: generate a plurality of first data signals by the image signal; and provide second data signals, obtained by interpolating the plurality of first data signals, to source lines among the plurality of source lines connected to pixels among the plurality of pixels that are displaying the second area.

According to an aspect of the disclosure, a method of driving a display device may include: turning off a source amplifier that outputs a data signal to a source line connected to a pixel during a first period in which the pixel displays an area rendered with a first quality; turning on the source amplifier during a second period before the pixel displays an area rendered with a second quality higher than the first quality; and outputting the data signal for the source amplifier to the source line connected to the pixel during a third period in which the pixel displays the area rendered with the second quality.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a display system according to one or more embodiments;

FIG. 2 is a block diagram illustrating a display panel of a display device according to one or more embodiments;

FIG. 3 is a block diagram illustrating a first display area and a second display area of a display panel in a display device according to one or more embodiments;

FIG. 4 illustrates a source driver providing a data signal to a source line;

FIG. 5 illustrates a portion of a display panel in which an image is displayed by the source driver of FIG. 4;

FIG. 6 illustrates a source driver providing a data signal to a source line according to one or more embodiments;

FIG. 7 illustrates a portion of a display panel in which an image is displayed by the source driver of FIG. 6;

FIG. 8 illustrates a source driver providing a data signal to a source line according to one or more embodiments;

FIG. 9 illustrates a source driver providing a data signal to a source line according to one or more embodiments;

FIG. 10 illustrates a portion of a display panel in which an image is displayed by the source driver of FIG. 9.

FIG. 11 illustrates a source driver providing a data signal to a source line according to one or more embodiments;

FIG. 12 illustrates a portion of a display panel in which an image is displayed by the source driver of FIG. 11;

FIG. 13 illustrates a portion of a pixel array included in a display panel in which an image is displayed by a source driver;

FIG. 14 illustrates a source driver providing a data signal to a source line according to one or more embodiments;

FIG. 15 illustrates a portion of a display panel in which an image is displayed by the source driver of FIG. 14;

FIG. 16 is a circuit diagram illustrating a source amplifier and a plurality of switches in a source driver according to one or more embodiments;

FIG. 17 is a timing diagram of control signals for controlling a source amplifier and a plurality of switches according to one or more embodiments;

FIG. 18 is a circuit diagram of a source amplifier and a plurality of switches in a first period;

FIG. 19 is a circuit diagram of a source amplifier and a plurality of switches in a second period;

FIG. 20 is a circuit diagram of a source amplifier and a plurality of switches in a third period;

FIG. 21 illustrates a source driver connected to a plurality of source lines through a multiplexer according to one or more embodiments;

FIG. 22 illustrates a source driver connected to a plurality of source lines through a multiplexer according to one or more embodiments; and

FIG. 23 is a diagram illustrating a display system according to one or more embodiments.

### DETAILED DESCRIPTION

Hereinafter, embodiments of this disclosure will be described in detail so that those of ordinary skill in the art to which this disclosure belongs can easily implement it with reference to the accompanying drawings. As those skilled in the art would realize, the described embodiments may be modified in various different ways, all without departing from the spirit or scope of the disclosure.

In addition, in order to clearly describe the present disclosure in the drawings, parts which are not related to the description have been omitted, and like reference numerals refer to similar parts throughout the specification. In the flowcharts described with reference to the drawings, the order of operation may be changed, various operations may be merged, any operation may be split, and certain operations may not be performed.

In addition, the expression written as singular can be interpreted as singular or plural, unless explicit expressions such as “one” or “single” are used. Terms including ordinal numbers such as first, second, etc. may be used to describe various components, but the components are not limited by these terms. These terms may be used for the purpose of distinguishing one component from another component.

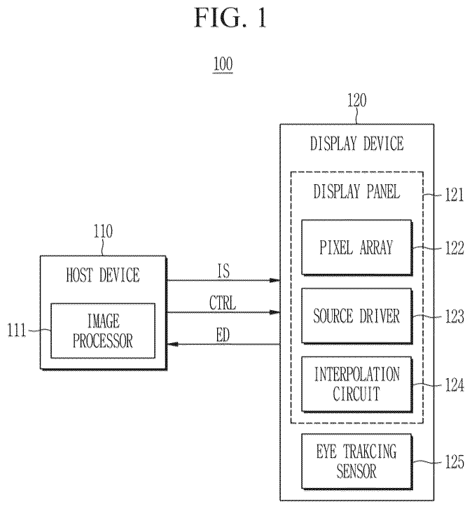

FIG. 1 is an example block diagram of a display system according to one or more embodiments.

Referring to FIG. 1, a display system 100 may provide a user with an artificial reality system, for example, a virtual reality (VR) system, an augmented reality (AR) system, a mixed reality (MR) system, a hybrid reality system, or some combination and/or derivative system thereof. In this case, the artificial reality system may be implemented in various platforms including a head mounted display (HMD), a mobile device, a computing system, or other hardware platforms capable of providing artificial reality content to one or more viewers.

Next, the display system 100 may include a host device 110 and a display device 120.

The host device 110 may be a computing device or a system for controlling the display device 120 to display a desired image by a user on the pixel array 122 from the outside. The host device 110 may transmit an image signal IS according to the content for presenting to the user to the display device 120. In some embodiments, the host device 110 may render a content generated when an application is executed into an image signal IS including a plurality of areas having different display qualities. The host device 110 may render the content generated when the application is executed into an image signal IS including a first area having a first quality (e.g., high resolution). The host device 110 may render the content generated when the application is executed into an image signal IS including a second area having a second quality (e.g., low resolution) lower than the first quality. In some embodiments, the second quality is higher than the first quality.

The host device 110 may include an image processor 111 that generates an image signal IS. In one or more embodiments, the image processor 111 may generate an image signal IS including a plurality of areas having different display qualities.

In some embodiments, the image processor 111 may perform rendering the image signal IS based on the eye tracking data ED received from the display device 120. Specifically, the image processor 111 may receive the eye tracking data ED from the eye tracking sensor 125 in the display device 120, and render differently the first area corresponding to the position of the user's eye and the second area which is the peripheral area of the first area based on the eye tracking data ED. For example, the image processor 111 may render the first area corresponding to the position of the user's eyes with the first quality and render the second area which is a peripheral area of the first area with the second quality.

The host device 110 may generate a driving control signal CTRL for driving the pixel array 122 based on the image signal IS. The host device 110 may transmit the generated driving control signal CTRL to the display device 120. In this case, the driving control signal CTRL may include a control command for controlling the display device 120, a setting data, and the like, and in one or more embodiments, the driving control signal CTRL may include an area indication data indicating a plurality of areas of the image according to the image signal IS.

In some embodiments, the area indication data may include information for the number of the plurality of areas and/or a coordinate data and a function data, etc. indicating the position of the plurality of areas within the image displayed on the display panel by the image signal IS. The image displayed on the display panel by the image signal IS may include a first display area (an area displaying the first area rendered with the first quality) and a second display area (an area displaying the second area rendered with the second quality). When the first display area has a rectangular shape, the area indication data for the first display area may include coordinate values of four vertices of the first display area.

The display device 120 may receive an image signal IS and a driving control signal CTRL which are transmitted from the host device 110 and may display two-dimensional or three-dimensional image according to the image signal IS to the user.

The display device 120 may include a display panel 121 and an eye tracking sensor 125. In some embodiments, the display device 120 may further include a power supply circuit such as a DC/DC converter that provides a driving voltage to the display panel 121 and the eye tracking sensor 125.

In one or more embodiments, the display panel 121 may display an image to the user according to the image signal IS received from the host device 110. In various embodiments, one or more display panels 121 may be provided. For example, two display panels 121 may provide an image for each eye of the user. The display panel 121 may be a liquid crystal display LCD, an organic light emitting diode OLED display, an inorganic light emitting diode ILED display, a transparent OLED display TOLED, and the like.

In one or more embodiments, the display panel 121 may include a pixel array 122, a source driver 123, and an interpolation circuit 124. The display panel 121 may have a backplane structure in which a pixel array 122, a source driver 123, and an interpolation circuit 124 are disposed on a silicon substrate (a silicon semiconductor substrate). For example, the display panel 121 may include a pixel array 122, a source driver 123, and an interpolation circuit 124 on a CMOS (Complementary Metal-Oxide-semiconductor) wafer.

The pixel array 122 may include a plurality of pixels, a plurality of gate lines, and a plurality of source lines respectively connected to the plurality of pixels. In one or more embodiments, a plurality of pixels may emit light primary colors such as red, green, blue, white, or yellow.

The source driver 123 may provide a plurality of data signals generated based on the image signal IS to a plurality of source lines. The source driver 123 may include a plurality of source amplifiers respectively connected to a plurality of source lines and output a plurality of data signals. In some embodiments, source amplifiers that output data signals corresponding to source lines connected to pixels displaying a first display area may be turned on among a plurality of source amplifiers. Among the plurality of source amplifiers, some of the source amplifiers that output data signals corresponding to source lines connected to pixels displaying the second display area may be turned off.

The interpolation circuit 124 may interpolate the data signals output from the source driver 123 and transmit it to the pixel array 122. The interpolation circuit 124 may transmit the data signal output from the source driver 123 to the source lines connected to pixels included in the first display area as it is. The interpolation circuit 124 may interpolate the data signal output from the source driver 123 and transmit it to the source lines connected to pixels included in the second display area.

The eye tracking sensor 125 may transmit the eye tracking data ED obtained by tracking the position and movement of the user's eyes (i.e. a user eye) to the host device 110. In this case, eye tracking may refer to determining the position of the eye, including the orientation and position of the eye relative to the display device 120. In one or more embodiments, an eye tracking system may include an imaging system for imaging one or more eyes. In some embodiments, the eye tracking system may include a light emitter that generates light directed to the eye such that the light reflected by the eye may be captured by the imaging system.

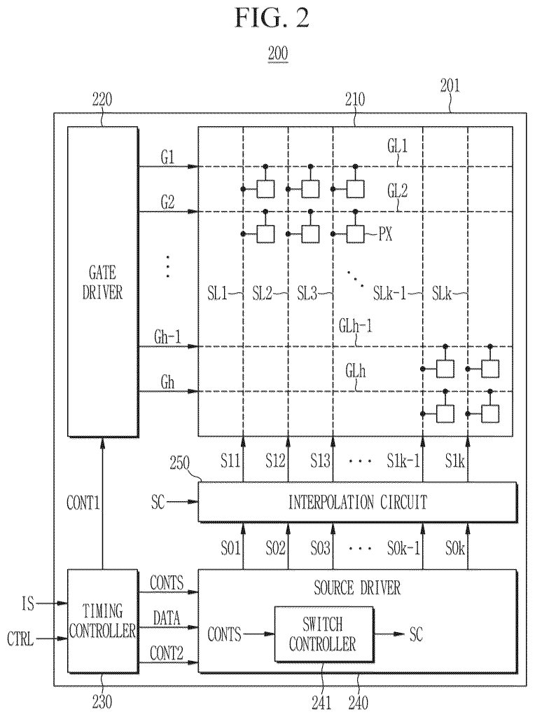

FIG. 2 is a block diagram illustrating a display panel of a display device according to one or more embodiments.

Referring to FIG. 2, the display panel 200 according to one or more embodiments may include a substrate 201, a pixel array 210, a gate driver 220, a timing controller 230, a source driver 240, and an interpolation circuit 250 positioned on the substrate 201.

The pixel array 210 may include a plurality of pixels PX for display images. Each of the plurality of pixels PX may be connected to one source line among the plurality of source lines SL1, SL2, . . . , SLk−1, and SLk, and one gate line among the plurality of gate lines GL1, GL2, . . . , GLh−1, and GLh.

The pixel PX connected to one source line among the plurality of source lines and one gate line among the plurality of gate lines may receive a data signal from the source line connected when a gate signal is supplied from the connected gate line. Based on the data signal input from a source line, a pixel may express light having predetermined luminance.

Referring to FIG. 2, although the pixel PX is shown to be connected to one source line and one gate line, the connection structure of the signal line connected to the pixel PX is not limited, and the signal line may be connected to the pixel in various currently known forms.

Next, the gate driver 220, the timing controller 230, the source driver 240, and the interpolation circuit 250 may be partially or entirely manufactured through a silicon wafer manufacturing process and implemented on the same substrate 201 as the pixel array 210. In addition, in some embodiments, the gate driver 220 and/or the source driver 240 may be implemented on the same substrate as the pixel array 210. The gate driver 220 and/or the source driver 240 may be disposed on the periphery of the pixel array 210.

Referring to FIG. 2, the timing controller 230 may receive the image signal IS and the driving control signal CTRL generated by the host device 110 of FIG. 1.

The timing controller 230 may generate the gate driver control signal CONT1 based on the driving control signal CTRL received from the host device 110. In addition, the timing controller 230 may provide the generated gate driver control signal CONT1 to the gate driver 220.

Referring to FIG. 2, based on the gate driver control signal CONT1, the gate driver 220 may provide a plurality of gate signals G1, G2, . . . , Gh−1, and Gh to each of the plurality of gate lines GL1, GL2, . . . , GLh−1, and GLh.

A plurality of gate signals G1, G2, . . . , Gh−1, and GH may be pulse-signals having an enable level and a disable level.

The gate driver 220 may sequentially apply a plurality of gate signals G1, G2, . . . , Gh−1, and Gh to each of the plurality of gate lines GL1, GL2, . . . , GLh−1, and GLh. For example, firstly, the gate driver 220 may apply a first gate signal G1 to the first gate line GL1. After all pixels connected to the first gate line GL1 receive the first gate signal G1 from the gate driver 220, the gate driver 220 may apply the second gate signal G2 to the second gate line GL2. After all pixels connected to the second gate line GL2 receive the second gate signal G2 from the gate driver 220, the gate driver 220 may apply the third gate signal G3 to the third gate line GL3.

During one horizontal period 1H, the gate driver 220 may apply a gate signal having an enable level to all pixels connected to one gate line. After 1H from the time point when the gate driver 220 provides the first gate signal G1 to the first gate line GL1, the gate driver 220 may provide the second gate signal G2 to the second gate line GL2.

The timing controller 230 may generate the source driver control signal CONT2 based on the driving control signal CTRL received from the host device 110 of FIG. 1. In addition, the timing controller 230 may provide the generated source driver control signal CONT2 to the source driver 240.

The timing controller 230 may generate a source amplifier control signal, based on the image signal IS received from the host device 110, for each of the plurality of source amplifiers included in the source driver 240 and transmit the source amplifier control signal to the source driver 240. In this case, the source amplifier control signal may be included in the source driver control signal CONT2.

The timing controller 230 may determine, based on the image signal IS received from the host device 110, whether a plurality of pixels connected to the plurality of source lines SL1, SL2, . . . , SLk−1, and SLk are included in the first display area. The timing controller 230 may generate a source amplifier control signal, when a pixel connected to the first source line is included in the first display area, for turning on the first source amplifier connected to the first source line. The timing controller 230 may generate a source amplifier control signal, when a pixel connected to the first source line is included in the second display area, for turning off the first source amplifier connected to the first source line. The timing controller 230 may transmit the generated source amplifier control signal to the source driver 240.

The timing controller 230 may generate a data DATA in the form of a digital signal corresponding to the image signal IS received from the host device 110. The timing controller 230 may transmit the generated data DATA in the form of a digital signal to the source driver 240. In this case, the data DATA in the form of a digital signal may include grayscale information corresponding to each pixel PX for displaying the image signal IS on the pixel array 210.

The timing controller 230 may generate a switch control signal CONTS based on the area indication data of the driving control signal CTRL received from the host device 110. When it is determined that the pixel connected to the first source line SL1 is included in the first display area based on the area indication data, the timing controller 230 may generate a switch control signal CONTS that opens the switch. When a pixel connected to the first source line SL1 is included in the second display area based on the area indication data, the timing controller 230 may generate a switch control signal CONTS that closes the switch.

Referring to FIG. 2, the source driver 240 may generate first data signals S01, S02, . . . , S0k−1, and S0k according to the source driver control signal CONT2 provided from the timing controller 230. The first data signals S01, S02, . . . , S0k−1, and S0k may be obtained by converting the data DATA in the form of a digital signal into the data signals S01, S02, . . . , S0k−1, and S0k in the form of an analog signal. The source driver 240 may transmit the generated first data signals S01, S02, . . . , S0k−1, and S0k to the interpolation circuit 250. In this case, the source driver 240 may be referred to as a data driver.

The source driver 240 may include a switch controller 241 that controls a plurality of switches included in the interpolation circuit 250. The switch controller 241 may receive the switch control signal CONTS from the timing controller 230 and generate the switch signal SC based on the switch control signal CONTS. For example, the switch controller 241 may generate a switch signal SC that differently drives a plurality of switches connecting a plurality of source lines connected to the pixel displaying the first display area and a plurality of switches connecting a plurality of source lines connected to the pixel displaying the second display area from the switch control signal CONTS.

The interpolation circuit 250 may receive the first data signals S01, S02, . . . , S0k−1, and S0k from the source driver 240 and output the second data signals S11, S12, . . . , S1k−1, and S1k from which the plurality of first data signals S01, S02, . . . , S0k−1, and S0k are interpolated. In some embodiments, the interpolation circuit 250 may provide a second data signal S12 obtained by interpolating a second data signal S11 corresponding to the first source line SL1 among the plurality of source lines SL1, SL2, . . . , SLk−1, and SLk and a second data signal S13 corresponding to the third source line SL3 among the plurality of source lines to the second source line SL2 between the first source line SL1 and the third source line SL3. In addition, a plurality of pixels included in the pixel array 210 may emit image light by the second data signals S11, S12, . . . , S1k−1, and S1k provided by the interpolation circuit 250.

The interpolation circuit 250 may include a plurality of switches. The plurality of switches may connect adjacent source lines among a plurality of source lines SL1, SL2, . . . . SLk−1, and SLk to each other. The plurality of switches may be controlled based on the switch signal SC generated by the switch controller 241.

For example, among the plurality of switches, a first switch may connect between the first source line SL1 and the second source line SL2, and a second switch may connect between the second source line SL2 and the third source line SL3. When the first switch and the second switch are closed based on the switch signal SC generated by the switch controller 241, the second source line SL2 may be electrically connected to the first source line SL1 and the third source line SL3.

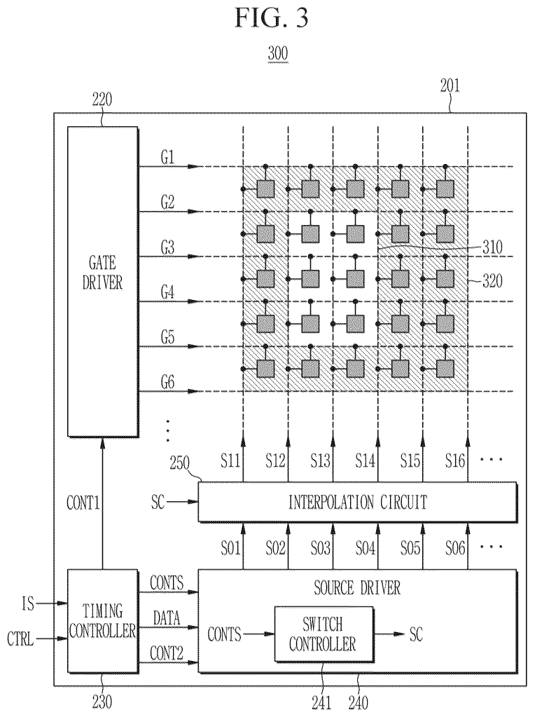

FIG. 3 is a block diagram illustrating a first display area and a second display area of a display panel in a display device according to one or more embodiments.

Referring to FIG. 3, the display panel 300 may include a first display area 310 and a second display area 320. The first display area 310 may mean an area displaying an area rendered with a first quality, and the second display area 320 may mean an area displaying an area rendered with the second quality lower than the first quality. In this case, the first display area 310 may be an area corresponding to the position of the user's eye, and the second display area 320 may be an area other than the first display area.

The switch controller 241 may receive a switch control signal CONTS from a timing controller 230 and generate a switch signal SC in order to differently drive a switch connected between a plurality of source lines based on a first display area 310 and a second display area 320.

For example, the switch signal SC may generate a signal to open a plurality of switches connected between a plurality of source lines connected to a plurality of pixels included in the first display area 310. The switch signal SC may generate a signal for closing a plurality of switches connected between a plurality of source lines connected to a plurality of pixels included in the second display area 320.

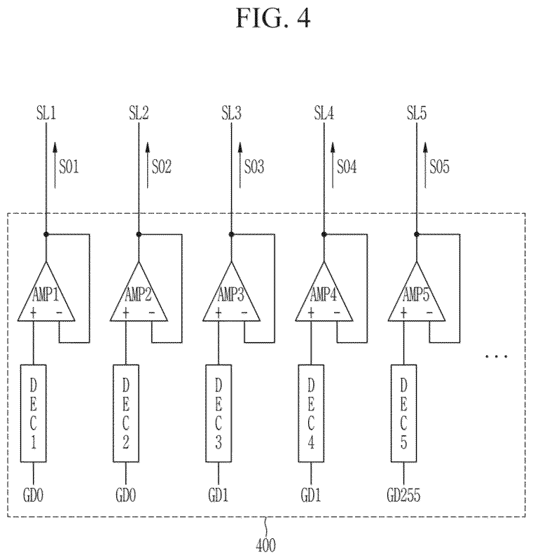

FIG. 4 illustrates a source driver providing a data signal to a source line.

Referring to FIG. 4, the source driver 400 may include a plurality of source amplifiers AMP1, AMP2, AMP3, AMP4, and AMP5 and a plurality of decoders DEC1, DEC2, DEC3, DEC4, and DEC5. The decoders DEC1, DEC2, DEC3, DEC4, and DEC5 may be connected to a non-inverting terminal of each of the plurality of source amplifiers AMP1, AMP2, AMP3, AMP4, and AMP5. The decoders DEC1, DEC2, DEC3, DEC4, and DEC5 may receive grayscale information corresponding to each pixel (PX) in the form of digital signal data.

The plurality of decoders DEC1, DEC2, DEC3, DEC4, and DEC5 may receive a plurality of voltages VG0, VG1, . . . , and VGH from a voltage generator together with the digital data GD0, GD0, GD1, GD1, GD255. When the digital data received by the plurality of decoders DEC1, DEC2, DEC3, DEC4, and DEC5 is 8-bit data, the number of the plurality of voltages VG0, VG1, . . . , and VGH may be 28 or less, and when the digital data received by the plurality of decoders DEC1, DEC2, DEC3, DEC4, and DEC5 is 10-bit data, the number of the plurality of voltages VG0, VG1, . . . , and VGH may be 210 or less. The plurality of decoders DEC1, DEC2, DEC3, DEC4, and DEC5 may select at least some of the input plurality of voltages VG0, VG1, . . . , and VGH and transmit them to the plurality of source amplifiers AMP1, AMP2, AMP3, AMP4, and AMP5.

Referring to FIG. 4, when the first digital data GD0 is input to the first decoder DEC1, the voltage transmitted by the first decoder DEC1 to the first source amplifier AMP1 may be VG0. When the third digital data GD1 is input to the third decoder DEC3, the voltage transmitted by the third decoder DEC3 to the third source amplifier AMP3 may be VG1. When the fifth digital data GD255 is input to the fifth decoder DEC5, the voltage transmitted from the fifth decoder DEC5 to the fifth source amplifier AMP5 may be VG255.

The plurality of source amplifiers AMP1, AMP2, AMP3, AMP4, and AMP5 may apply voltages VG0, VG0, VG1, VG1, and VG255 respectively received from the plurality of decoders DEC1, DEC2, DEC3, DEC4, and DEC5 to the pixels connected to the plurality of source lines SL1, SL2, SL3, SL4, and SL5.

Referring to FIG. 4, since the same digital data GD0 is input to the first decoder DEC1 and the second decoder DEC2 and the same digital data GD1 is input to the third decoder DEC3 and the fourth decoder DEC4, the logic consumption power for processing the digital data may be reduced as compared to when digital data representing different grayscale information is input to the first decoder December 1, the second decoder December 2, the third decoder December 3, and the fourth decoder December 4.

Specifically, the logic consumption power refers to the power to process the digital data when the digital logic circuit is operated, and if the same digital data is processed, the operation speed of the logic circuit is increased and the data bandwidth is reduced, so the logic consumption power to process the same digital data may be reduced than the logic consumption power to process different digital data.

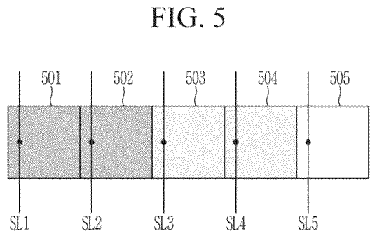

FIG. 5 illustrates a portion of a display panel on which an image is displayed by the source driver of FIG. 4.

Referring to FIGS. 4 and 5, the same digital data GD0 may be input to the first decoder DEC1 and the second decoder DEC2. The first pixel 501 connected to the first source line SL1 and the second pixel 502 connected to the second source line SL2 may emit light with substantially the same brightness.

The same digital data GD1 may be input to the third decoder DEC3 and the fourth decoder DEC4. The third pixel 503 connected to the third source line SL3 and the fourth pixel 504 connected to the fourth source line SL4 may emit light with substantially the same brightness.

The different digital data GD0, GD1, and GD255 may be input to the first decoder DEC1, the third decoder DEC3, and the fifth decoder DEC5, respectively. The first pixel 501 connected to the first source line SL1, the third pixel 503 connected to the third source line SL3, and the fifth pixel 505 connected to the fifth source line SL5 may emit light with different brightness each other.

The method in which the same digital data GD0 is input to decoder 1 DEC1 and decoder 2 DEC2 and the same digital data GD4 is input to decoder 3 DEC3 and decoder 4 DEC4 may reduce the logic consumption power to process digital data compared to the method in which different digital data is input to each of decoder 1 DEC1 through decoder 4 DEC4. However, since the first source amplifier AMP1 to the fifth source amplifier AMP5 are turned on, current consumption may occur in the source driver 400 regardless of the identity of digital data input to each of the first decoder DEC1, the second decoder DEC2, the third decoder DEC3, the fourth decoder DEC4, and the fifth decoder DEC5. That is, even if digital data input to the plurality of decoders DEC1, DEC2, DEC3, DEC4, and DEC5 are the same, the amount of power savings generated by the source driver may be insignificant.

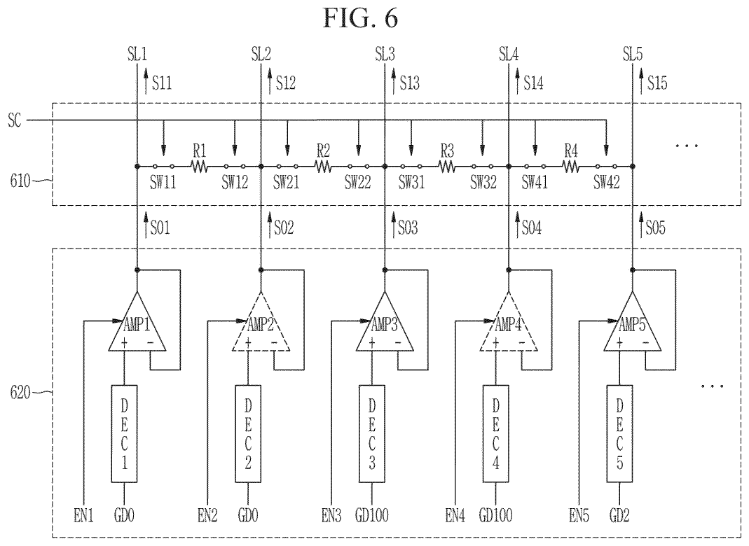

FIG. 6 illustrates a source driver providing a data signal to a source line according to one or more embodiments.

In FIG. 6, the interpolation circuit 610 may include a plurality of resistors R1, R2, R3, and R4 and a plurality of switches SW11, SW12, SW21, SW22, SW31, SW32, SW41, and SW42. In this case, a first resistor R1 may be connected between the first source line SL1 and the second source line SL2, a first switch SW11 may be connected between the first source line SL1 and the first resistor R1, and a second switch SW12 may be connected between the second source line SL2 and the first resistor R1. In addition, a second resistor R2 may be connected between the second source line SL2 and the third source line SL3, a third switch SW21 may be connected between the second source line SL2 and the second resistor R2, and a fourth switch SW22 may be connected between the third source line SL3 and the second resistor R2. That is, each of the plurality of source lines SL1, SL2, SL3, SL4, and SL5 may be connected to another adjacent source line through a resistor, and a switch may be connected to both sides of the resistor.

The interpolation circuit 610 may receive a plurality of first data signals S01, S03, and S05 and a switch signal SC from the source driver 620. In this case, the plurality of first data signals S01, S03, and S05 may be converted into the second data signals S11, S13, and S15 through the interpolation circuit 610 and then may be provided to the plurality of source lines SL1, SL3, and SL5, respectively. In addition, operations of the plurality of switches SW11, SW12, SW21, SW22, SW31, SW32, SW41, and SW42 included in the interpolation circuit 610 may be controlled based on the switch signal SC.

When the pixels connected to the plurality of source lines SL1, SL2, SL3, SL4, and SL5 are included in the first display area, the switch signal SC received by the interpolation circuit 610 may be different from the switch signal SC received by the interpolation circuit 610 when the pixels connected to the plurality of source lines SL1, SL2, SL3, SL4, and SL5 are included in the second display area 320 of FIG. 3. When the pixels connected to the plurality of source lines SL1, SL2, SL3, SL4, and SL5 are included in the first display area 310 of FIG. 3, the plurality of switches SW11, SW12, SW21, SW22, SW31, SW32, SW41, and SW42 may be opened based on the switch signal SC. When the pixels connected to the plurality of source lines SL1, SL2, SL3, SL4, and SL5 are included in the second display area 320, some of the plurality of switches SW11, SW12, SW21, SW22, SW31, SW32, SW41, and SW42 may be closed based on the switch signal SC.

When a plurality of pixels connected to the plurality of source lines SL1, SL2, SL3, SL4, and SL5 are included in the second display area 320, the timing controller 230 of FIG. 2 may transmit the source amplifier control signals EN2 and EN4 for turning off the second source amplifier AMP2 and the fourth source amplifier AMP4 to the source driver 620.

When a plurality of pixels connected to a plurality of source lines SL1, SL2, SL3, SL4, and SL5 are included in the second display area 320, the switch controller 241 of FIG. 2 may generate a switch signal SC for closing a plurality of switches SW11, SW12, SW21, SW22, SW42, SW41, and SW42 positioned at both sides of each of the first resistor R1, the second resistor R2, the third resistor R3, and the fourth resistor R4.

The interpolation circuit 610 may receive the first data signal S01 and the first data signal S03 and transmit the second data signal S12 interpolated by the first resistor R1 and the second resistor R2 to the second source line SL2. The interpolation circuit 610 may receive the first data signal S03 and the first data signal S05 and transmit the second data signal S14 interpolated by the third resistor R3 and the fourth resistor R4 to the fourth source line SL4. In addition, the second source amplifier AMP2 connected to the second source line SL2 and the fourth source amplifier AMP4 connected to the fourth source line SL4 receiving the second data signals S12 and S14 may be turned off based on the source amplifier control signals EN2 and EN4.

The second data signal S12 may have a voltage in which the voltage of the first data signal S01 and the voltage of the first data signal S03 are divided according to the magnitudes of the first resistor R1 and the second resistor R2. The second data signal S14 may have a voltage in which the voltage of the first data signal S03 and the voltage of the first data signal S05 are divided according to the magnitudes of the third resistor R3 and the fourth resistor R4. The voltage of the second data signals S12 and S14 may be calculated according to Equations 1 and 2 below.

S12=(R1*S03+R2*S01)/(R1+R2) [Equation 1]

Here, S12 may be a voltage of the second data signal S12, R1 may be a first resistor, S03 may be a voltage of the first data signal S03, R2 may be a second resistor, and S01 may be a first data signal S01.

S14=(R3*S05+R4*S03)/(R3+R4) [Equation 2]

Here, S14 may be a voltage of the second data signal S14, R3 may be a third resistor, S05 may be a voltage of the first data signal S05, R4 may be a fourth resistor, and S03 may be a first data signal S03.

That is, the voltages of the interpolated second data signals S12 and S14 may be calculated by using voltages VDATA(0), VDATA(100), and VDATA(200) of the first data signals S11, S13, and S15 to be subject of interpolation and a plurality of resistors R1, R2, R3, and R4 connecting the plurality of source lines SL1, SL2, SL3, SL4, SL5 to each other. In this case, the voltages VDATA(0), VDATA(100), and VDATA(200) of the first data signals S11, S13, and S15 to be interpolated may be determined based on the digital data GD0, GD100, and GD200 applied to the plurality of decoders DEC1, DEC3, and DEC5.

Referring to FIG. 6, a static current may be generated from the resistors R1, R2, R3, and R4 in the interpolation circuit 610. However, since the voltage difference of the data signal applied to the adjacent pixel will be insufficient, the power consumption due to the static current generated by the resistors R1, R2, R3, and R4 in the interpolation circuit 610 may be insufficient. Rather, since the source amplifier corresponding to the source line transmitting the interpolated data is turned off, the power consumption generated from the display panel may be reduced.

As the number of pixels connected to the plurality of source lines SL1, SL2, SL3, SL4, and SL5 included in the second display area 320 increases, more source amplifiers are turned off and may reduce power consumption generated from the display panel, and thus the size of the second display area 320 may be set wider than that of the first display area 321.

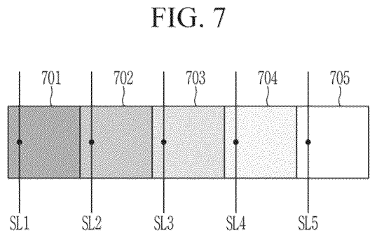

FIG. 7 illustrates a portion of a display panel on which an image is displayed by the source driver of FIG. 6.

Referring to FIGS. 6 and 7, it may be seen that the first digital data GD0 is input to the first decoder DEC1, the second digital data GD0 is input to the second decoder DEC2, the third digital data GD100 is input to the third decoder DEC3, the fourth digital data GD100 is input to the fourth decoder DEC4, the fifth digital data GD200 is input to the fifth decoder DEC5, and the second source amplifier AMP2 and the fourth source amplifier AMP4 corresponding to the second source line SL2 and the fourth source line SL4 are turned off. Accordingly, the brightness of the second pixel 702 connected to the second source line SL2 and the fourth pixel 704 connected to the fourth source line SL4 may be determined regardless of the grayscale information input to the second decoder DEC2 and the fourth decoder DEC4.

According to the present disclosure, although the same digital data GD0 is applied to the decoder 2 DEC2 as to the decoder 1 DEC1, the second data signal S12 interpolated by the first data signals S01 and S03 may be provided to the second source line SL2 connected to the second source amplifier AMP2 in the off state. Although the same digital data GD100 is applied to the fourth decoder 4 DEC4 as to the third decoder 3 DEC3, the second data signal S14 interpolated by the first data signals S01 and S03 may be provided to the fourth source line SL4 connected to the fourth source amplifier AMP4 in the off state.

The brightness of the second pixel 702 connected to the second source line SL2 may have a value between the brightness of the first pixel 701 connected to the first source line SL1 and the brightness of the third pixel 703 connected to the third source line SL3. In this case, the brightness of the second pixel 702 may be determined based on values of the first resistor R1 and the second resistor R2 of the interpolation circuit 610.

For example, when the first resistor R1 has a higher resistance value than the second resistor R2, the brightness of the second pixel 702 connected to the second source line SL2 may be determined to be close to the brightness of the third pixel 703 connected to the third source line SL3. On the other hand, when the first resistor R1 has a lower resistance value than the second resistor R2, the brightness of the second pixel 702 connected to the second source line SL2 may be determined to be close to the brightness of the first pixel 701 connected to the first source line SL1.

Likewise, in the case of the fourth pixel 704 connected to the fourth source line SL4, there may be a value between the brightness of the third pixel 703 connected to the third source line SL3 and the brightness of the fifth pixel 705 connected to the fifth source line SL5. When the third resistor R3 has a higher resistance value than the fourth resistor R4, the brightness of the fourth pixel 704 connected to the fourth source line SL4 may be determined to be close to the brightness of the fifth pixel 705 connected to the fifth source line SL5. When the third resistor R3 has a resistance value lower than the fourth resistor R4, the brightness of the fourth pixel 704 connected to the fourth source line SL4 may be determined to be close to the brightness of the third pixel 703 connected to the third source line SL3.

The pixels 702 and 704 included in the second display area may receive the second data signals S12 and S14 for various grayscale information due to interpolation through the first to fourth resistors R1, R2, R3, and R4. The pixels 702 and 704 included in the second display area may display various grayscale levels based on the second data signals S12 and S14. Accordingly, the image quality of the second display area of the foveated rendered image may be improved.

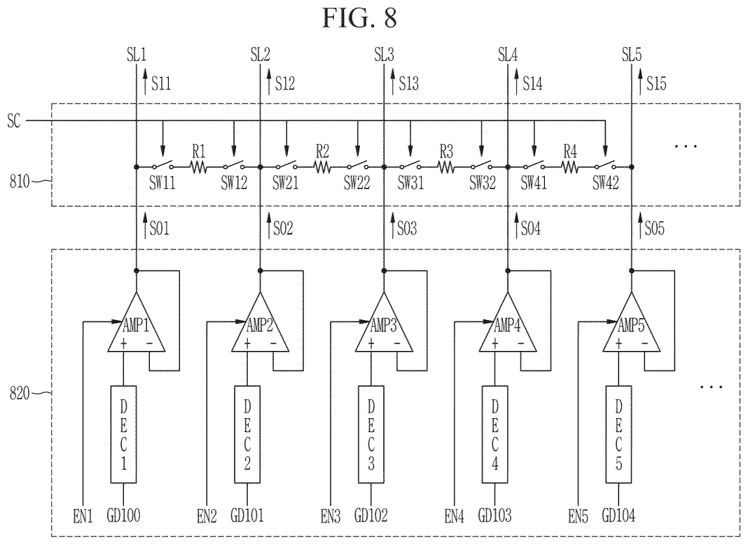

FIG. 8 illustrates a source driver providing a data signal to a source line according to one or more embodiments.

Referring to FIG. 8, a plurality of pixels connected to a plurality of source lines SL1, SL2, SL3, SL4, and SL5 may be included in the first display area 310 of FIG. 3. In this case, the switch signal SC may open a plurality of switches SW11, SW12, SW21, SW22, SW31, SW32, SW41, and SW42 in the interpolation circuit 810. The timing controller 230 of FIG. 2 may transmit the source amplifier control signals EN1, EN2, EN3, EN4, and EN5 operating all of the plurality of source amplifiers AMP1, AMP2, AMP3, AMP4, and AMP5 connected to the plurality of source lines SL1, SL2, SL3, SL4 and SL5 to the source driver 820.

The plurality of source lines SL1, SL2, SL3, SL4, and SL5 may receive the plurality of data signals S01, S02, S03, S04, and S05 from the source driver 820 based on the respective digital data GD100, GD101, GD102, GD103, and GD104 input to the decoders DEC1, DEC2, DEC3, DEC4, and DEC5 connected to the source amplifier.

The brightness of the first pixel connected to the first source line SL1 may be determined based on the first digital data GD100 input to the first decoder DEC1, the brightness of the second pixel connected to the second source line SL2 is determined based on the second digital data GD101 input to the second decoder DEC2, and the brightness of the third pixel connected to the third source line SL3 may be determined based on the third digital data GD102 input to the third decoder DEC3. Likewise, the brightness of the fourth pixel connected to the fourth source line SL4 may be determined based on the fourth digital data GD103 input to the fourth decoder DEC4, and the brightness of the fifth pixel connected to the fifth source line SL5 may be determined based on the fifth digital data GD104 input to the fifth decoder DEC5.

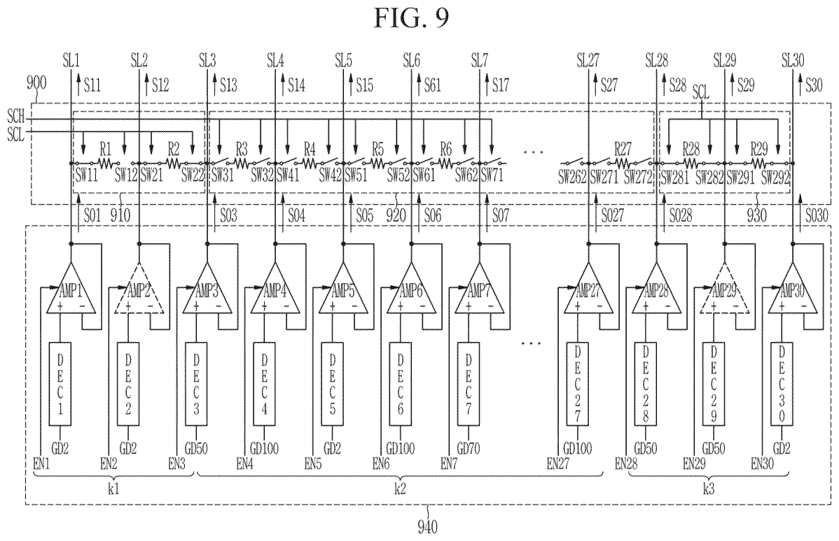

FIG. 9 illustrates a source driver providing a data signal to a source line according to one or more embodiments.

Referring to FIG. 9, the interpolation circuit 900 may include a first interpolation circuit 910, a second interpolation circuit 920, and a third interpolation circuit 930. The first interpolation circuit 910 may mean a circuit in which the first source line SL1, the second source line SL2, and the third source line SL3 are connected through a plurality of resistors R1 and R2 and a plurality of switches SW11, SW12, SW21, and SW22. The second interpolation circuit 920 may mean a circuit in which the third source line SL3 to the 28th source line SL28 are connected through a plurality of resistors R3 to R27 and a plurality of switches SW31, SW32, SW41, SW42, SW51, SW52, SW61, SW62, SW71 to SW272. The third interpolation circuit 930 may mean a circuit in which the 28th source line SL28, the 29th source line SL29, and the 30th source line SL30 are connected through a plurality of resistors R28 and R29 and a plurality of switches SW281, SW282, SW291, and SW292.

Referring to FIG. 9, a pixel connected to the first source line SL1 to the third source line SL3 may be included in the first area k1, a pixel connected to the fourth source line SL4 to the 27th source line SL27 may be included in the second area k2, and a pixel connected to the 28th source line SL28 to the 30th source line SL30 may be included in the third area k3. In this case, the first area k1 and the third area k3 may mean the second display area 320 of FIG. 3, and the second area k2 may mean the first display area 310 of FIG. 3.

The source driver 940 may include a plurality of source amplifiers AMP1 to AMP30 and a plurality of decoders DEC1 to DEC30. The source driver 940 may receive a second source amplifier control signal EN2 for turning off the second source amplifier AMP2 and the 29th source amplifier control signal EN29 for turning off the 29th source amplifier AMP2 from the timing controller 230 of FIG. 2.

The plurality of switches SW11, SW12, SW21, and SW22 included in the first interpolation circuit 910 may receive signals SCL for controlling to close the switch from the switch controller 241 of FIG. 2. The plurality of switches SW31, SW32, SW41, and SW42 to SW272 included in the second interpolation circuit 920 may receive signals SCL for controlling to open the switch from the switch controller 241. The plurality of switches SW281, SW282, SW291, and SW292 included in the third interpolation circuit 930 may receive a signal SCL for controlling to close the switch from the switch controller 241.

A plurality of pixels connected to each of the source lines SL1, SL2, and SL3 included in the first area k1 may receive a plurality of second data signals S11, S12, and S13 through the first interpolation circuit 910. In this case, the second data signal S12 may be obtained by interpolating a plurality of first data signals S01 and S03.

A plurality of pixels connected to each of the plurality of source lines SL4 to SL27 included in the second area k2 may receive a plurality of second data signals S14 to S27 through the second interpolation circuit 920.

A plurality of pixels connected to each of the plurality of source lines SL28 to SL30 included in the third area k3 may receive a plurality of second data signals S28 to S30 through the third interpolation circuit 930. In this case, the second data signal S29 may be obtained by interpolating a plurality of first data signals S28 and S30.

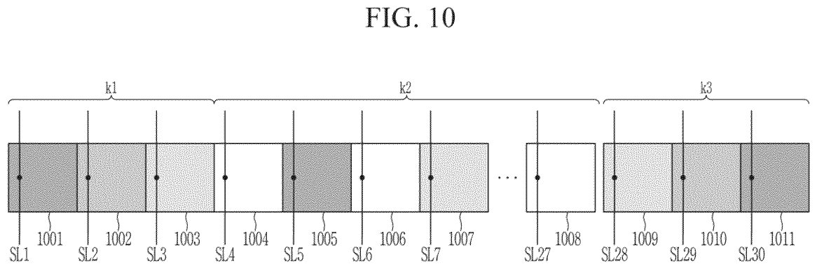

FIG. 10 illustrates a portion of a display panel on which an image is displayed by the source driver of FIG. 9.

Referring to FIGS. 9 and 10, first digital data GD2 may be input to the first decoder DEC1, and third digital data GD50 may be input to the third decoder DEC3. The 28th digital data GD50 may be input to the 28th decoder DEC28, and the 30th digital data GD2 may be input to the 30th decoder DEC30. In addition, the second source amplifier AMP2 and the 29th source amplifier AMP29 connected to the second source line SL2 and the 29th source line SL29 may be turned off.

Accordingly, the brightness of the second pixel 1002 connected to the second source line SL2 and the 29th pixel 1010 connected to the 29th source line SL29 may be determined regardless of the second digital data GD2 input by the second decoder DEC2 and the 29th digital data GD50 input by the 29th decoder DEC29.

Specifically, in the case of the second pixel 1002 connected to the second source line SL2, there may be a value between the brightness of the first pixel 1001 connected to the first source line SL1 and the brightness of the third pixel 1003 connected to the third source line SL3. In addition, in the case of the 29th pixel 1010 connected to the 29th source line SL29, there may be a value between the brightness of the 28th pixel 1009 connected to the 28th source line SL28 and the brightness of the 30th pixel 1011 connected to the 30th source line SL30. The brightness of the second pixel 1002 and the 29th pixel 1010 may be determined based on the values of the first resistor R1, the second resistor R2, the third resistor R3, and the fourth resistor R4 included in the first interpolation circuit 910 and the third interpolation circuit 930.

For example, when the first resistor R1 has a higher resistance value than the second resistor R2, the brightness of the second pixel 1002 connected to the second source line SL2 may be determined to be close to the brightness of the third pixel 1003 connected to the third source line SL3. On the other hand, when the first resistor R1 has a lower resistance value than the second resistor R2, the brightness of the second pixel 1002 connected to the second source line SL2 may be determined to be close to the brightness of the first pixel 1001 connected to the first source line SL1.

Likewise, when the 28th resistor R28 has a higher resistance value than the 29th resistor R29, the brightness of the 29th pixel 1010 connected to the 29th source line SL29 may be determined to be close to the brightness of the 30th pixel 1011 connected to the 30th source line SL30, and when the 28th resistor R28 has a lower resistance value than the 29th resistor R29, the brightness of the 29th pixel 1010 connected to the 29th source line SL29 may be determined to be close to the brightness of the 28th pixel 1009 connected to the 28th source line SL28.

Next, referring to FIGS. 9 and 10, the brightness of the fourth pixel 1004 connected to the fourth source line SL4 is determined based on the fourth digital data GD100 input to the fourth decoder DEC4, the brightness of the fifth pixel 1005 connected to the fifth source line SL5 is determined based on the fifth digital data GD2 input to the fifth decoder DEC5, and the brightness of the sixth pixel 1006 connected to the sixth source line SL6 may be determined based on the sixth digital data GD100 input to the sixth decoder DEC6. In addition, the brightness of the seventh pixel 1007 connected to the seventh source line SL7 is determined based on the seventh digital data GD70 input to the seventh decoder DEC7, and the brightness of the 27th pixel 1008 connected to the 27th source line SL27 may be determined based on the 27th digital data GD100 input to the 27th decoder DEC27.

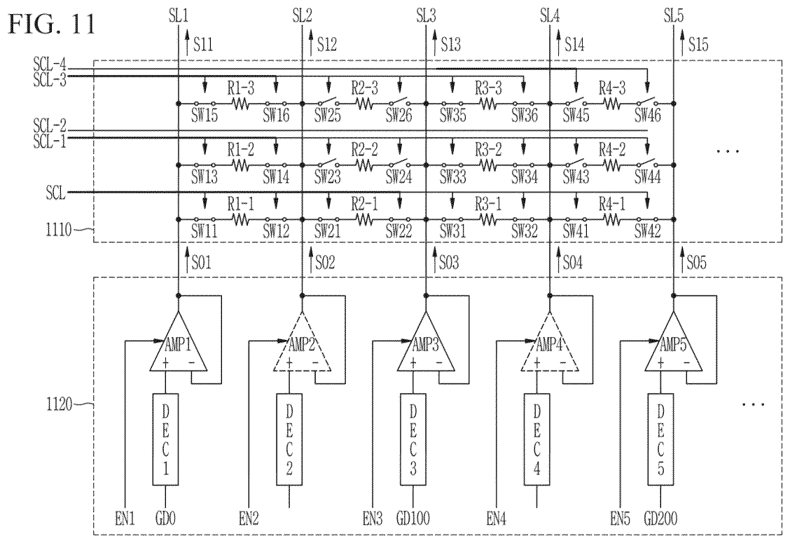

FIG. 11 illustrates a source driver providing a data signal to a source line according to one or more embodiments.

Prior to the description of FIG. 11, the pixels connected to each of the plurality of source lines SL1, SL2, SL3, SL4, and SL5 may be included in the second display area 320 of FIG. 3, and the second source amplifier AMP2 and the fourth source amplifier AMP4 included in the source driver 1120 may be in an off state.

Referring to FIG. 11, the interpolation circuit 1110 may include a plurality of resistors (R1-1, R1-2, R1-3, R2-1, R2-2, R2-3, R3-1, R3-2, R3-3, R4-1, R4-2, and R4-3) connected in parallel and a plurality of switches (SW11, SW12, SW13, SW14, SW15, SW16, SW21, SW22, SW23, SW23 SW24, SW25, SW26, SW31, SW32, SW33, SW34, SW35, SW36, SW41, SW42, SW43, SW44, SW45, and SW46) connected to both side of a plurality of resistors (R1-1, R1-2, R1-3, R2-1, R2-2, R2-3, R3-1, R3-2, R3-3, R4-1, R4-2, and R4-3), respectively. In this case, each of the plurality of resistors R1-1, R1-2, R1-3, R2-1, R2-2, R2-3, R3-1, R3-2, R3-3, R4-1, R4-2, and R4-3, may be connected to a plurality of adjacent source lines SL1, SL2, SL3, SL4, and SL5.

The interpolation circuit 1110 may include a plurality of first resistors R1-1, R1-2, and R1-3 connected in parallel between the first source line SL1 and the second source line SL2, a plurality of first switches SW11, SW13, and SW15 connected between one end of each of the plurality of first resistors R1, R1-2, and R1-3 and the first source line SL1, and a plurality of second switches SW12, SW14, and SW16 connected between the other end of each of the plurality of first resistors R1-1, R1-2, and R1-3 and the second source line SL2.

The interpolation circuit 1110 may include a plurality of second resistors R2-1, R2-2, and R2-3 connected in parallel between the second source line SL2 and the third source line SL3, a plurality of third switches SW21, SW23, and SW25 connected between one end of each of a plurality of second resistors R2-1, R2-2, and R2-3 and the second source line SL2, and a plurality of fourth switches SW22, SW24, and SW26 connected between the other end of each of a plurality of second resistors R2-1, R2-2, and R2-3 and the third source line SL3. In addition, the plurality of third resistors R3-1, R3-2, and R3-, the plurality of fourth resistors R4-1, R4-2, and R4-3 and the plurality of switches SW31, SW32, SW33, SW34, SW35, SW36, SW41, SW42, SW43, SW44, SW45, and SW46 included in the interpolation circuit 1110 may be also connected in the above manner.

In the present disclosure, the switch controller 241 of FIG. 2 may generate a switch signal SC of FIG. 2 for controlling a plurality of switches SW11, SW12, SW13, SW14, SW15, SW21, SW22, SW23, SW24, SW25, SW26, SW31, SW32, SW33, SW34, SW35, SW36, SW41, SW42, SW43, SW44, SW45, and SW46 included in the interpolation circuit. In this case, the switch signal SC may include one of a signal for opening a switch and a signal for closing the switch. The switch controller 241 may individually provide switch signals SC to the plurality of switches SW11, SW12, SW13, SW14, SW15, SW16, SW21, SW22, SW23, SW24, SW25, SW26, SW31, SW32, SW33, SW34, SW35, SW36, SW41, SW42, SW43, SW44, SW45, and SW46. In addition, the switch controller 241 may provide the same switch signal SC for each of the two switches directly connected to both sides of the plurality of resistors R1-1, R1-2, R2-3, R3-1, R3-2, R3-3, R4-1, R4-2, and R4-3.

In one or more embodiments, among the plurality of resistors R1-1, R1-2, R-3, R2-1, R2-2, R3-3, R4-1, R4-2, and R4-3 included in an interpolation circuit 1110, a plurality of switches SW11, SW12, SW21, SW22, SW31, SW32, SW41, and SW42 connected to both sides of the resistors R1-1, R1-2, R1-3, R2-1, R2-2, R3-3, R4-1 adjacent to the source driver 1120 may receive a switch signal SCL in which the switch is closed from the switch controller 241.

Among a plurality of resistors included in the interpolation circuit 1110, a plurality of switches SW13, SW14, SW33, and SW34 connected to both sides of the resistors R1-2 and R3-2 located at the upper side of the resistor adjacent to the source driver 1120 may receive the switch signal SCL-1 in which the switch is closed from the switch controller 241. Among a plurality of resistors included in the interpolation circuit 1110, a plurality of switches SW23, SW24, SW43, and SW44 connected to both sides of the resistors R2-2, and R4-2 located at the upper side of the resistor adjacent to the source driver 1120 may receive the switch signal SCL-2 in which the switch is open from the switch controller 241.

Among a plurality of resistors included in the interpolation circuit 1110, a plurality of switches SW15, SW16, SW35, and SW36 connected to both sides of the resistors R1-3, and R3-3 located at the upper side in the interpolation circuit 1110 may receive the switch signal SCL-3 in which the switch is closed from the switch controller 241. Among a plurality of resistors included in the interpolation circuit 1110, a plurality of switches SW25, SW26, SW45, and SW46 connected to both sides of the resistors R2-3, and R4-3 located at the upper side in the interpolation circuit 1110 may receive the switch signal SCL-4 in which the switch is closed from the switch controller 241.

Referring to FIG. 11, the method of providing the same switch signal SC for each of the two switches directly connected to both sides of the plurality of resistors (R1-1, R1-2, R1-3, R2-1, R2-2, R2-3, R3-1, R3-2, R3-3, R4-1, R4-2, and R4-3) may significantly reduce the number of switch signal lines compared to the method in which the plurality of switches (SW11, SW12, SW13, SW14, SW15, SW16, SW21, SW22, SW23, SW24, SW25, SW26, SW31, SW32, SW33, SW34, SW35, SW36, SW41, SW42, SW43, SW44, SW45, and SW46) receive the switch signal SC individually.

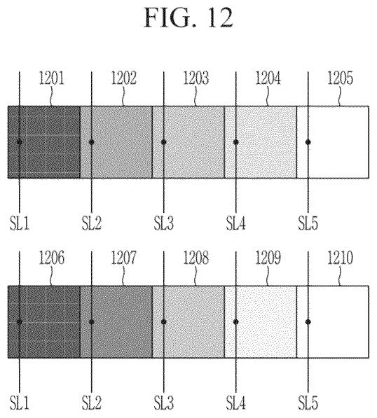

FIG. 12 illustrates a portion of a display panel on which an image is displayed by the source driver of FIG. 11.

Referring to FIGS. 11 and 12, it will be explained assuming that all of the resistors (R1-1, R1-2, R1-3, R2-1, R2-2, R2-3, R3-1, R3-2, R3-3, R4-1, R4-2, and R4-3) of FIG. 11 have the same resistance value R.

The brightness of the first pixel 1201 connected to the first source line SL1, the second pixel 1202 connected to the second source line SL2, the third pixel 1203 connected to the third source line SL3, the fourth pixel 1204 connected to the fourth source line SL4, and the fifth pixel 1205 connected to the fifth source line SL5 may represent when all the switches SW11, SW12, SW13, SW14, SW15, SW16, SW21, SW22, SW23, SW24, SW25, SW26, SW31, SW32, SW33, SW34, SW35, SW36, SW41, SW42, SW43, SW44, SW45, and SW46 included in the interpolation circuit 1110 of FIG. 11 are closed.

Since a plurality of switches SW11, SW12, SW13, SW14, SW15, and SW16 connected between the first source line SL1 and the second source line SL2 are all closed, a plurality of resistors R1-1, R1-2, and R1-3 connected in parallel between the first source line SL1 and the second source line SL2 may have a total R/3 value.

Since the plurality of switches SW21, SW22, SW23, SW24, SW25, and SW26 connected between the second source line SL2 and the third source line SL3 are all closed, the plurality of resistors R2-1, R2-2, and R2-3 connected in parallel between the second source line SL2 and the third source line SL3 may have a total R/3 value.

Since a plurality of switches SW31, SW32, SW33, SW34, SW35, and SW36 connected between the third source line SL3 and the fourth source line SL4 are all closed, a plurality of resistors R3-1, R3-2, and R3-3 connected in parallel between the third source line SL3 and the fourth source line SL4 may have a total R/3 value.

Since the plurality of switches SW41, SW42, SW43, SW44, SW45, and SW46 connected between the fourth source line SL4 and the fifth source line SL5 are all closed, the plurality of resistors R4-1, R4-2, and R4-3 connected in parallel between the fourth source line SL4 and the fifth source line SL5 may have a total R/3 value.

A first digital data GD0 may be input to the first decoder DEC1, a third digital data GD100 may be input to the third decoder DEC3, and a fifth digital data GD200 may be input to the fifth decoder DEC5. In addition, the second source amplifier AMP2 and the fourth source amplifier AMP4 corresponding to the second source line SL2 and the fourth source line SL4 may be turned off. Accordingly, the brightness of the second pixel 1202 connected to the second source line SL2 and the fourth pixel 1204 connected to the fourth source line SL4 may be determined regardless of digital data input to the second decoder DEC2 and the fourth decoder DEC4.

Specifically, in the case of the second pixel 1202 connected to the second source line SL2, there may be a value between the brightness of the first pixel 1201 connected to the first source line SL1 and the brightness of the third pixel 1203 connected to the third source line SL3. In addition, in the case of the fourth pixel 1204 connected to the fourth source line SL4, there may be a value between the brightness of the third pixel 1203 connected to the third source line SL3 and the brightness of the fifth pixel 1205 connected to the fifth source line SL5.

Next, the first pixel 1206 connected to the first source line SL1, the second pixel 1207 connected to the second source line SL2, the third pixel 1208 connected to the third source line SL3, the fourth pixel 1209 connected to the fourth source line SL4, and the fifth pixel 1210 connected to the fifth source line SL5 indicate the brightness of the pixel when the plurality of switches SW23, SW24, SW25, SW26, SW33, SW34, SW35, and SW36 included in the interpolation circuit 1110 are opened, and the plurality of switches SW11, SW12, SW13, SW14, SW15, SW16, SW21, SW22, SW31, SW32, SW41, SW42, SW43, SW44, SW45, and SW46 are closed.

In this case, the total resistance values of a plurality of resistors R1-1, R1-2, and R1-3 connected in parallel between the first source line SL1 and the second source line SL2 may have an R/3 value, and the total resistance values of a plurality of resistors R2-1, R2-2, and R2-3 connected in parallel between the second source line SL2 and the third source line SL3 may have an R value. In addition, the total resistance values of the plurality of resistors R3-1, R3-2, and R3-3 connected in parallel between the third source line SL3 and the fourth source line SL4 may have an R value, and the total resistance values of the plurality of resistors R4-1, R4-2, and R4-3 connected in parallel between the fourth source line SL4 and the fifth source line SL5 may have an R/3 value.

Accordingly, the brightness of the second pixel 1207 connected to the second source line SL2 may be determined to be close to the brightness of the first pixel 1206 connected to the first source line SL1. The brightness of the fourth pixel 1209 connected to the fourth source line SL4 may be determined to be close to the brightness of the fifth pixel 1210 connected to the fifth source line SL5.

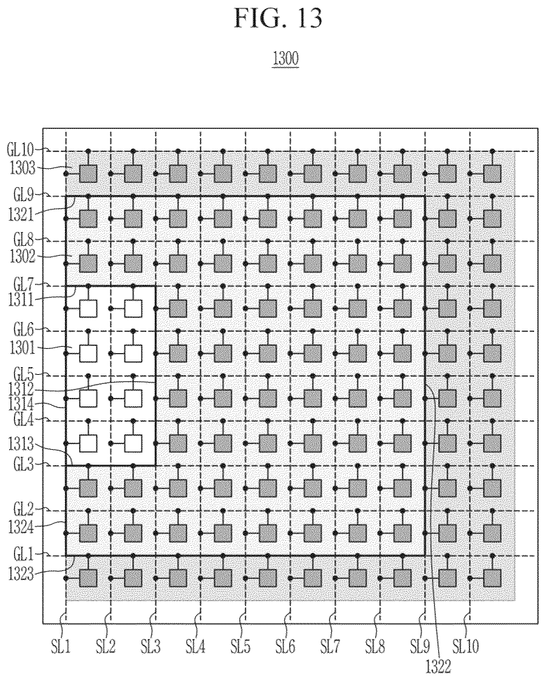

FIG. 13 illustrates a portion of a pixel array included in a display panel on which an image is displayed by a source driver.

Referring to FIG. 13, the pixel array 1300 may include a plurality of pixels for displaying an image, and the plurality of pixels may be included in the first display area 1301, the second display area 1302, and the third display area 1303 in the pixel array 1300. A plurality of pixels may express light having different luminance for each of the display areas 1301, 1302, and 1303. In this case, the first display area 1301 may be an area displaying a area rendered with a first quality, the second display area 1302 may be an area displaying an area rendered with a second quality lower than the first quality, and the third display area 1303 may be an area displaying an area rendered with a third quality lower than the second quality. For example, the first display area 1301, the second display area 1302, and the third display area 1303 may be areas displaying areas rendered in 10×, 4×, and 1× qualities, respectively.

The first display area 1301 may be an area displaying a focus area in which the user's gaze is seated or fixed based on the eye tracking data ED of FIG. 1. In this case, the size of the focus area may be based on an arc/angle covered by the user's gaze or a movement amount of the user's gaze.

In the present disclosure, the second display area 1302 and the third display area 1303 may be determined based on the degree of separation from the first display area 1301. Specifically, the degree of separation may be determined based on an adjacent distance from a plurality of pixels included in the upper, right, lower and left outer borders 1311, 1312, 1313, and 1314 of the first display area 1301 to a plurality of pixels included in the upper, right, lower and left outer borders 1321, 1322, 1323, and 1324 of the second display area 1302. In this case, the degree of separation may mean a distance between the gate lines GL1, GL2, GL3, . . . , and GL10 or the source lines SL1, SL2, SL3, . . . , SL10 from the upper, right, lower and left outer borders 311, 1312, 1313, and 1314 of the first display area 1301 to the upper, right, lower and left outer borders 1321, 1322, 1323, and 1324 of the second display area 1302.

A plurality of pixels within the first display area 1301 that are at a distance less than a first reference value from the upper outer border 1311 may be included in the second display area 1302, and a plurality of pixels within the first display area 1301 that are at a distance equal to or greater than a first reference value from the upper outer border 1311 may be included in the third display area 1303.

A plurality of pixels within the first display area 1301 that are at a distance less than a second reference value from the right outer border 1312 may be included in the second display area 1302, and a plurality of pixels within the first display area 1301 that are at a distance equal to or greater than a second reference value from the right outer border 1312 may be included in the third display area 1303.

A plurality of pixels within the first display area 1301 that are at a distance less than a third reference value from the lower outer border 1313 may be included in the second display area 1302, and a plurality of pixels within the first display area 1301 that are at a distance equal to or greater than a third reference value from the lower outer border 1313 may be included in the third display area 1303.

A plurality of pixels within the first display area 1301 that are at a distance less than a fourth reference value from the left outer border 1314 may be included in the second display area 1302, and a plurality of pixels within the first display area 1301 that are at a distance equal to or greater than a fourth reference value from the left outer border 1314 may be included in the third display area 1303.

The second display area 1302 may include a plurality of pixels spaced apart according to first to fourth reference values from each of the plurality of pixels included in the upper, right, lower, and left outer borders 1311, 1312, 1313, and 1314 of the first display area 1301. For example, a distance between two gate lines from pixels included in the upper outer border 1311 of the first display area 1301 may be set as a first reference value. A distance between the six source lines from the pixels included in the right outer border 1312 of the first display area 1301 may be set as a second reference value. A distance between the two gate lines from the pixels included in the lower outer border 1313 of the first display area 1301 may be set as a third reference value. A distance between zero (0) number of the source line from pixels included in the left outer border 1314 of the first display area 1301 may be set as a fourth reference value.

The pixels of the upper outer border 1321 of the second display area 1302 may be connected to the ninth gate line GL9 separated by two gate lines from the seventh gate line GL7 to which the pixels of the upper outer border 1311 of the first display area 1301 are connected. The pixels of the right outer border 1322 of the second display area 1302 may be connected to the eighth source line SL8 separated by six source lines from the second source line SL2 to which the pixels of the right outer border 1312 of the first display area 1301 are connected. The pixels of the lower outer border 1323 of the second display area 1302 may be connected to the second gate line GL2 separated by two gate lines from the fourth gate line GL4 to which the pixels of the lower outer border 1313 of the first display area 1301 are connected. The pixels of the left outer border 1324 of the second display area 1302 may be connected to the first source line SL1 to which pixels of the left outer border 1314 of the first display area 1301 are connected.

The third display area 1303 may include a spaced border apart from the outer borders 1311, 1312, 1313, and 1314 of the first display area 1301 according to a predetermined criterion. For example, the pixels included in the upper side of the third display area 1303 may be connected to the tenth gate line GL10 separated by three gate lines from the seventh gate line GL7 to which pixels of the upper border 1311 of the first display area 1301 are connected. The pixels included on the right side of the third display area 1303 may be connected to the tenth source line SL10 separated by eight source lines from the second source line SL2 to which the pixels on the right border 1312 of the first display area 1301 are connected. The pixels included in the lower side of the third display area 1303 may be connected to the first gate line GL1 separated by three gate lines from the fourth gate line GL4 to which the pixels of the lower border 1313 of the first display area 1301 are connected. The pixels included in the left side of the third display area 1303 may be connected to the first source line SL1 to which pixels of the left border 1314 of the first display area 1301 are connected.

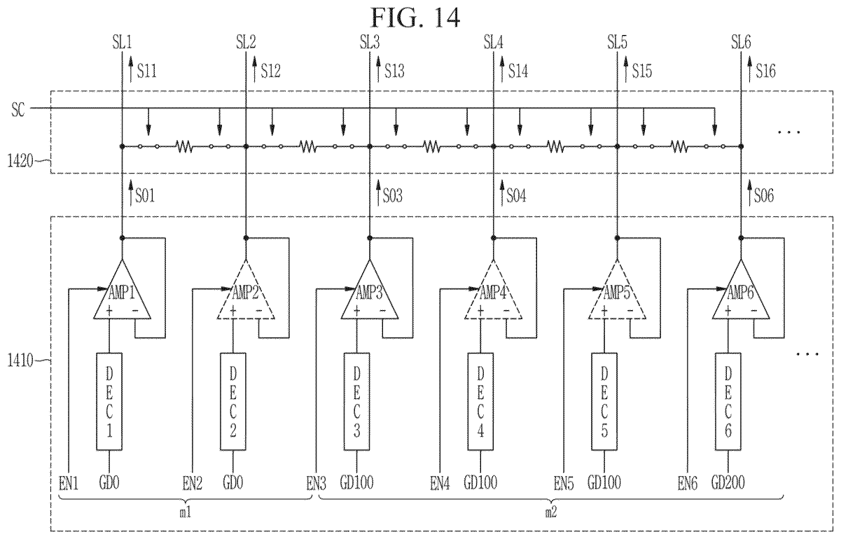

FIG. 14 illustrates a source driver providing a data signal to a source line according to one or more embodiments.

Referring to FIGS. 13 and 14, a pixel connected to each of the first source line SL1 and the second source line SL2 may be included in the first area m1, and a pixel connected to the third source line SL3, the fourth source line SL4, the fifth source line SL5, and the sixth source line SL6 may be included in the second area m2. In this case, the first area m1 may mean a second display area 1302 of FIG. 13, and the second area m2 may mean a third display area 1303 of FIG. 13. And, the switch controller 241 of FIG. 2 may generate a switch signal SC that closes all switches connected to the first source line SL1 to the sixth source line SL6 in the interpolation circuit 1420.

In addition, a plurality of switches in the interpolation circuit 1420 may be driven based on the switch signal SC received from the switch controller 241. The source driver 1410 may include a plurality of source amplifiers AMP1, AMP2, AMP3, AMP4, AMP5, and AMP6 and a plurality of decoders DEC1, DEC2, DEC3, DEC4, DEC5, and DEC6. The plurality of first data signals S01, S03, S04, and S06 received from the source driver 1410 may be converted into second data signals S11, S13, S14, and S16 via the interpolation circuit 1420 and then may be provided to the plurality of source lines SL1, SL3, SL4, and SL6, respectively.

In addition, when the first source line SL1 and the second source line SL2 are included in the first area m1, the timing controller 230 of FIG. 2 may transmit a source amplifier control signal EN2 for turning off the second source amplifier AMP2 connected to the second source line SL2 to the second source amplifier AMP2.

In addition, when the third source line SL3 to the sixth source line SL6 are included in the second area m2, the timing controller 230 may transmit the source amplifier control signals EN4 and EN5 to the fourth source amplifier AMP4 and the fifth source amplifier AMP5 for turning off the fourth source amplifier AMP4 and the fifth source amplifier AMP5 connected to the fourth source line SL4 and the fifth source line SL5.

In addition, in the second area m2, two off state amplifiers AMP4 and AMP5 are placed between the on-state amplifiers AMP3 and AMP6, but the present disclosure is not limited thereto. For example, the further away from the first display area 1301 of FIG. 13, the greater the number of off state amplifiers may be placed between the on state amplifiers. In this way, by turning off more source amplifiers connected with the source lines included in the display area further away based on their distance from the first display area 1301, the amount of power saving generated from the source driver 1410 may be increased.

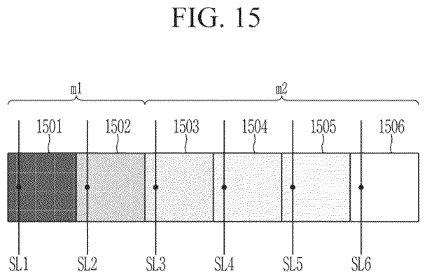

FIG. 15 illustrates a portion of a display panel on which an image is displayed by the source driver of FIG. 14.

Referring to FIGS. 14 and 15, it may be seen that the first digital data GD0 is input to the first decoder DEC1, the third digital data GD100 is input to the third decoder DEC3, the sixth digital data GD200 is input to the sixth decoder DEC6, and the second source amplifier AMP2, the fourth source amplifier AMP4, and the fifth source amplifier AMP5 connected to the second source line SL2, the fourth source line SL4, and the fifth source line SL5 are turned off. Accordingly, the brightness of the second pixel 1502 connected to the second source line SL2, the fourth pixel 1504 connected to the fourth source line SL4, and the fifth pixel 1505 connected to the fifth source line SL5 may be determined regardless of the digital data GD0, GD100, and GD100 received from the second decoder DEC2, the fourth decoder DEC4, and the fifth decoder DEC5, respectively.

Specifically, in the case of the second pixel 1502 connected to the second source line SL2, there may be a value between the brightness of the first pixel 1501 connected to the first source line SL1 and the brightness of the third pixel 1503 connected to the third source line SL3.

In addition, the fourth pixel 1504 connected to the fourth source line SL4 and the fifth pixel 1505 connected to the fifth source line SL5 may have a value between the brightness of the third pixel 1503 connected to the third source line SL3 and the brightness of the sixth pixel 1506 connected to the sixth source line SL6. In addition, the fourth pixel 1504 may be closer to the brightness of the third pixel 1503 than the fifth pixel 1505, and the fifth pixel 1505 may be closer to the brightness of the sixth pixel 1506 than the fourth pixel 1504.

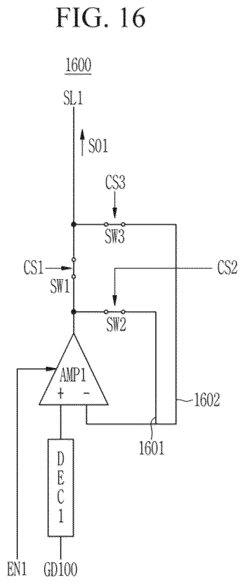

FIG. 16 is a circuit diagram illustrating a source amplifier and a plurality of switches in a source driver according to one or more embodiments.

Referring to FIG. 16, the source driver 1600 may include a first source amplifier AMP1, a first decoder DEC1, a first switch SW1, a second switch SW2, and a third switch SW3. The first source amplifier AMP1 may be connected to the first source line SL1 through a first switch SW1, a second switch SW2, and a third switch SW3. The first switch SW1 may be connected to the first source line SL1 connected to the output terminal of the first source amplifier AMP1. The second switch SW2 may be connected to the first signal line 1601 connected between the inverting terminal of the first source amplifier AMP1 and the first switch SW1. The third switch SW3 may be connected to the inverting terminal of the first source amplifier AMP1 and the second signal line 1602 connected to the first source line SL1. In this case, the second signal line may be a signal line in which an upper end of the first switch SW1 connected on the first source line SL1 and an inverting terminal of the first source amplifier AMP1 are connected.

The gate driver 220 of FIG. 2 may provide gate signals to all pixels connected to one gate line among the plurality of gate lines. After 1H, which is the time taken for the gate driver 220 to apply the gate signal to all pixels connected to one gate line, the gate driver 220 may provide the gate signal to another gate line. In addition, the source driver 1600 may provide the first data signal to a plurality of source lines corresponding to the gate line in response to the gate signal of the gate driver 220.

Referring to FIG. 16, the source driver 1600 may apply the first data signal to the pixel included in the second display area 1302 of FIG. 13 and then apply the first data signal to the pixel included in the first display area 1301 of FIG. 13 after 1H. In this case, while the source driver 1600 applies the first data signal to the pixel included in the second display area 1302 of FIG. 13, the first source amplifier AMP1 may be off state. The first source amplifier AMP1 may receive a source amplifier control signal EN1 for turning off the first source amplifier AMP1 from the timing controller 230 of FIG. 2.

A ready-state of the source amplifier will be described by dividing into a first period P01 which is off-state of the source amplifier of the first source amplifier AMP1, a second period P02 which is ready-state of the source amplifier of the first source amplifier AMP1, and a third period P03 which is the on-state of the source amplifier of the third source amplifier AMP3.

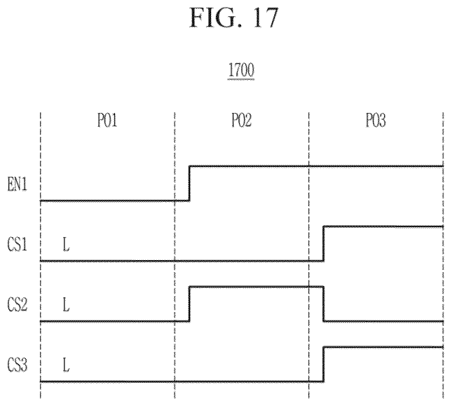

FIG. 17 is a timing diagram of control signals for controlling a source amplifier and a plurality of switches according to one or more embodiments.

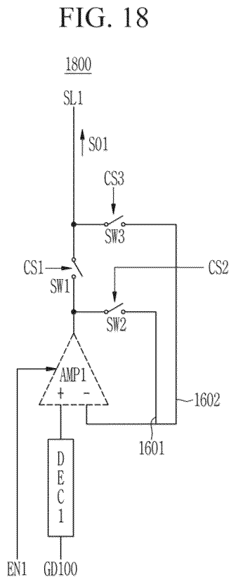

In the first period P1, the first source amplifier AMP1 may receive a source amplifier control signal EN1 for turning off the first source amplifier AMP1 from the timing controller 230 of FIG. 2. The first switch SW1, the second switch SW2, and the third switch SW3 may receive switch signals CS1, CS2, and CS3 for opening the switch from the switch controller 241 of FIG. 2. The circuit diagram will be described with reference to FIG. 18.

FIG. 18 is a circuit diagram of a source amplifier and a plurality of switches in a first period.

Referring to FIGS. 17 and 18, since the first source amplifier AMP1 is turned off state and all switches SW1, SW2, and SW3 are open, the first data signal provided by the source driver 240 of FIG. 2 to the first source line SL1 may not be generated. In this case, the first data signal corresponding to the adjacent source line may be interpolated through the interpolation circuit 250 of FIG. 2, and the interpolated second data signal may be provided to the first source line SL1.

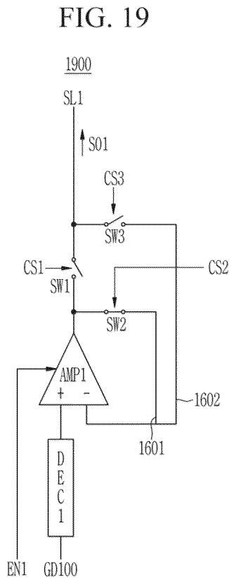

Next, according to FIG. 17, in the second period P02, the first source amplifier AMP1 may receive the source amplifier control signal EN1 for operating the first source amplifier AMP1 from the timing controller 230 of FIG. 2. The first switch SW1 and the third switch SW3 may receive switch signals CS1 and CS3 for opening the switch from the switch controller 241 of FIG. 2. In addition, the second switch SW2 may receive a switch signal CS2 for closing the switch from the switch controller 241. This will be described with reference to FIG. 19. This will be described with reference to FIG. 19.

FIG. 19 is a circuit diagram of a source amplifier and a plurality of switches in a second period.

Referring to FIGS. 17 and 19, the first source amplifier AMP1 may be in an on-state, the first switch SW1 and the third switch SW3 may be open, and the second switch SW2 may be closed. In this case, the first data signal provided by the source driver 240 of FIG. 2 to the first source line SL1 may not be generated because the first switch SW1 is open, but the second switch SW2 is closed so that the first source amplifier AMP1 may be driven in advance. When the pre-driven first source amplifier AMP1 is used, an image quality delay phenomenon caused by a time to drive the first source amplifier AMP1 in the third period P03 may be prevented.

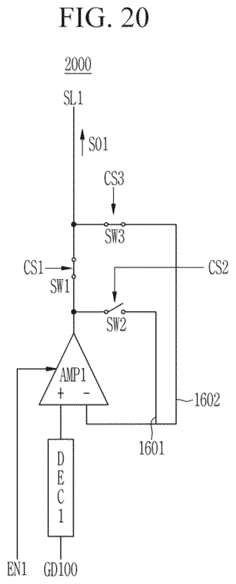

Next, according to FIG. 17, in the third period P03, the first source amplifier AMP1 may receive the source amplifier control signal EN1 for operating the first source amplifier AMP1 from the timing controller 230 of FIG. 2. In addition, the first switch SW1 and the third switch SW3 may receive switch signals CS1 and CS3 for closing the switch from the switch controller 241 of FIG. 2, and the second switch SW2 may receive a switch signal CS2 for opening the switch from the switch controller 241. This will be described with reference to FIG. 20. This will be described with reference to FIG. 20.

FIG. 20 is a circuit diagram of a source amplifier and a plurality of switches in a third period.

Referring to FIGS. 17 and 20, the first source amplifier AMP1 may be in an on state, the first switch SW1 and the third switch SW3 may be closed, and the second switch SW2 may be open. In this case, since the first switch SW1 is closed, the first data signal S01 provided by the source driver 240 of FIG. 2 to the first source line SL1 may be generated. In addition, since the first source amplifier AMP1 previously driven in the second period P02 may be used in the third period P03, image quality delay phenomenon caused by the time to drive the first source amplifier AMP1 may be prevented.

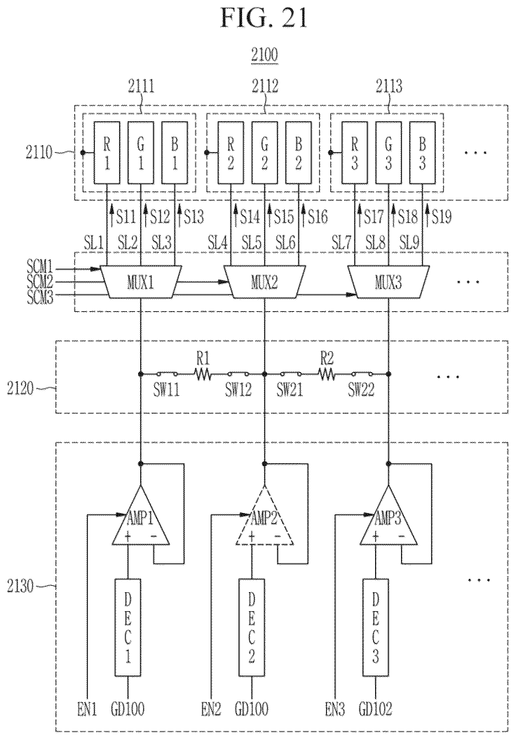

FIG. 21 illustrates a source driver connected to a plurality of source lines through a multiplexer according to one or more embodiments.

Referring to FIG. 21, each of a plurality of pixels 2111, 2112, and 2113 may include n sub-pixels. For example, each of the plurality of pixels 2111, 2112, and 2113 may include three R, G, and B sub-pixels. Each of the plurality of pixels 2111, 2112, and 2113 may include three sub-pixels of the same color. The plurality of source lines SL1 to SL9 may be connected to sub-pixels in the plurality of pixels 2111, 2112, and 2113, respectively.

A plurality of source lines SL1 to SL9 may be connected to the source driver 2130 through the interpolation circuit 2120. The interpolation circuit 2120 may include a first resistor R1, a second resistor R2, and a plurality of switches SW11, SW12, SW21, and SW22. The source driver 2130 may include a first source amplifier AMP1, a second source amplifier AMP2, a third source amplifier AMP3, a first decoder DEC1, a second decoder DEC2, and a third decoder DEC3.

Referring to FIG. 21, the second source amplifier AMP2 may receive a source amplifier control signal EN2 for turning off the second source amplifier AMP2 from the timing controller 230 of FIG. 2. Accordingly, the brightness of the plurality of sub-pixels R2, G2, and B2 included in the second pixel 2112 may be determined regardless of the digital data GD100 input to the second decoder DEC2.

Referring to FIG. 21, the first multiplexer MUX1 may be connected to three sub-pixels R1, G1, and B1 included in the first pixel 2111. The first multiplexer MUX1 may receive the first multiplexer control signal SCM1 from the timing controller 230 of FIG. 2. The first multiplexer MUX1 may apply the second data signals S11, S12, and S13 to only one sub-pixel among the three connected sub-pixels R1, G1, and B1 based on the first multiplexer control signal SCM1.

The second multiplexer MUX2 may be connected to three sub-pixels R2, G2, and B2 included in the second pixel 2112. The second multiplexer MUX2 may receive the second multiplexer control signal SCM2 from the timing controller 230. The second multiplexer MUX2 may apply the second data signals S14, S15, and S16 to only one sub-pixel among the three connected sub-pixels R2, G2, and B2 based on the second multiplexer control signal SCM2.

The third multiplexer MUX3 may be connected to three sub-pixels R3, G3, and B3 included in the third pixel 2113. The third multiplexer MUX3 may receive the third multiplexer control signal SCM3 from the timing controller 230. The third multiplexer MUX3 may apply the second data signals S17, S18, and S19 to only one sub-pixel among the three connected sub-pixels R3, G3, and B3 based on the third multiplexer control signal SCM3.

The first multiplexer MUX1, the second multiplexer MUX2, and the third multiplexer MUX3 may apply data signals to only one sub-pixel of the same color based on the first multiplexer control signal SCM1, the second multiplexer control signal SCM2, and the third multiplexer control signal SCM3 generated from the timing controller 230. For example, the first multiplexer MUX1, the second multiplexer MUX2, and the third multiplexer MUX3 may apply the second data signals S11, S14, and S17 to only the R-colored sub-pixels R1, R2, and R3 among the plurality of sub-pixels connected based on the first multiplexer control signal SCM1, the second multiplexer control signal SCM2, and the third multiplexer control signal SCM3.

The second data signal S14 interpolated through the interpolation circuit 2120 may be applied to the R sub-pixel R2 included in the second pixel 2112. In this case, the interpolated data signal may be obtained by interpolating a first data signal applied to the R sub-pixel R1 included in the first pixel 2111 and a first data signal applied to the R sub-pixel R3 included in the third pixel 2113. Accordingly, the brightness of the R sub-pixel R2 included in the second pixel 2112 may have a value between the brightness of the R sub-pixel R1 included in the first pixel 2111 and the brightness of the R sub-pixel R3 included in the third pixel 2113.

Similarly, the second data signal S15 interpolated through the interpolation circuit 2120 may be applied to the G sub-pixel G2 included in the second pixel 2112. In this case, the interpolated data signal may be obtained by interpolating a first data signal applied to the G sub-pixel G1 included in the first pixel 2111 and a first data signal applied to the G sub-pixel G3 included in the third pixel 2113. Accordingly, the brightness of the G sub-pixel G2 included in the second pixel 2112 may have a value between the brightness of the G sub-pixel G1 included in the first pixel 2111 and the brightness of the G sub-pixel G3 included in the third pixel 2113.

The second data signal S16 interpolated through the interpolation circuit 2120 may be applied to the B sub-pixel B2 included in the second pixel 2112. In this case, the interpolated data signal may be obtained by interpolating the first data signal applied to the B sub-pixel B1 included in the first pixel 2111 and the first data signal applied to the B sub-pixel B3 included in the third pixel 2113. Accordingly, the brightness of the B sub-pixel B2 included in the second pixel 2112 may have a value between the brightness of the B sub-pixel B1 included in the first pixel 2111 and the brightness of the B sub-pixel B3 included in the third pixel 2113.

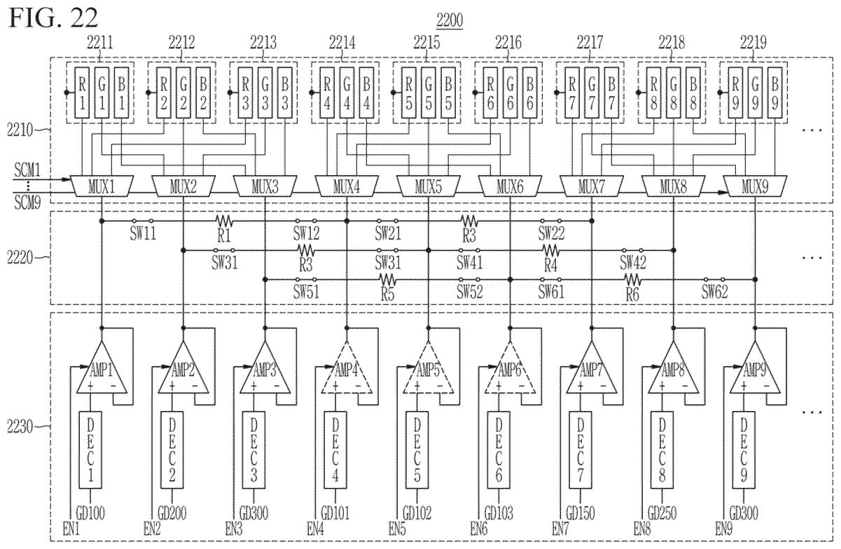

FIG. 22 illustrates a source driver connected to a plurality of source lines through a multiplexer according to one or more embodiments.

Referring to FIG. 22, the first multiplexer MUX1 to the ninth multiplexer MUX9 may apply a second data signal to only one sub-pixel (R1, G1, B1, R2, G2, B2, R3, G3, B3, R4, G4, B4, R5, G5, B5, R6, G6, B6, R7, G7, B7, R8, G8, B8, R9, G9, and B9) among R, G, and B sub-pixels (R1, G1, B1, R2, G2, B2, R3, G3, B3, R4, G4, B4, R5, G5, B5, R6, G6, B6, R7, G7, B7, R8, G8, B8, R9, G9, and B9) included in each of the first pixel 2211 to ninth pixel 2219 based on the first multiplexer control signal SCM1 to the ninth multiplexer control signal SCM9. In this case, the first multiplexer control signal SCM1 to the ninth multiplexer control signal SCM9 may be generated by the timing controller 230 of FIG. 2.

The interpolation circuit 2120 may include a first resistor R1, a second resistor R2, a third resistor R3, a fourth resistor R4, a fifth resistor R5, and a sixth resistor R6, and may include a plurality of switches SW11, SW12, SW21, SW22, SW31, SW32, SW41, SW42, SW51, SW52, SW61, and SW62 connected to both sides of each resistor.

The source driver 2130 may include a first source amplifier AMP1, a second source amplifier AMP2, a third source amplifier AMP3, a fourth source amplifier AMP4, a fifth source amplifier AMP5, a sixth source amplifier AMP6, a seventh source amplifier AMP7, an eighth source amplifier AMP8, and a ninth source amplifier AMP9. The source driver 2130 may include first to ninth decoders DEC1 to DEC9 connected to respective source amplifiers.

Referring to FIG. 22, the fourth source amplifier AMP4, the fifth source amplifier AMP5, and the sixth source amplifier AMP6 may receive source amplifier control signals EN4, EN5, and EN6 from the timing controller 230 for turning off the fourth source amplifier AMP4, the fifth source amplifier AMP5, and the sixth source amplifier AMP6, respectively. Accordingly, the brightness of the plurality of sub-pixels R4, G4, B4, R5, G5, B5, R6, G6, and B6 included in the fourth pixel 2214, the fifth pixel 2215, and the sixth pixel 2216 may be determined irrespective of the digital data GD101, GD102, and GD103 input to the fourth decoder DEC4, the fifth decoder DEC5, and the sixth decoder DEC6.

The second data signal applied to the R sub-pixels R4, R5, and R6 included in the fourth pixel 2214, the fifth pixel 2215, and the sixth pixel 2216 may be applied with an interpolated data signal based on the interpolation circuit 2220 of the present disclosure. In this case, the interpolated data signal may be obtained by interpolating a first data signal applied to the R sub-pixels R1, R2, and R3 included in the first pixel 2211, the second pixel 2212, and the third pixel 2213 and a first data signal applied to the R sub-pixels R7, R8, and R9 included in the seventh pixel 2217, the eighth pixel 2218, and the ninth pixel 2219. Accordingly, the brightness of the R sub-pixels R4, R5, and R6 included in the fourth pixel 2214, the fifth pixel 2215, and the sixth pixel 2216 may have a value between the brightness of the R sub-pixels R1, R2, and R3 included in the first pixel 2211, the second pixel 2212, the third pixel 2213 and the brightness of the R sub-pixels R7, R8, and R9 included in the seventh pixel 2217, the eighth pixel 2218, and the ninth pixel 2219.

The second data signal applied to the G sub-pixels G4, G5, and G6 included in the fourth pixel 2214, the fifth pixel 2215, and the sixth pixel 2216 may be applied with an interpolated data signal based on the interpolation circuit 2220 of the present disclosure. In this case, the interpolated data signal may be obtained by interpolating the first data signal applied to the G sub-pixels G1, G2, and G3 included in the first pixel 2211, the second pixel 2212, and the third pixel 2213, and the first data signal applied to the G sub-pixels G7, G8, and G9 included in the seventh pixel 2217, the eighth pixel 2218, and the ninth pixel 2219. Accordingly, the brightness of the G sub-pixels G4, G5, and G6 included in the fourth pixel 2214, the fifth pixel 2215, and the sixth pixel 2216 may have a value between the brightness of the G sub-pixels G1, G2, and G3 included in the first pixel 2211, the second pixel 2212, and the third pixel 2213 and the brightness of the G sub-pixels G7, G8, and G9 included in the seventh pixel 2217, the eighth pixel 2218, the ninth pixel 2219.

The second data signal applied to the B sub-pixels B4, B5, and B6 included in the fourth pixel 2214, the fifth pixel 2215, and the sixth pixel 2216 may be applied with an interpolated data signal based on the interpolation circuit 2220 of the present disclosure. In this case, the interpolated data signal may be obtained by interpolating the first data signal applied to the B sub-pixels B1, B2, and B3 included in the first pixel 2211, the second pixel 2212, and the third pixel 2213, and the first data signal applied to the B sub-pixels B7, B8, and B9 included in the seventh pixel 2217, the eighth pixel 2218, and the ninth pixel 2219. Accordingly, the brightness of the B sub-pixels B4, B5, and B6 included in the fourth pixel 2214, the fifth pixel 2215, and the sixth pixel 2216 may have a value between the brightness of the B sub-pixels B1, B2, and B3 included in the first pixel 2211, the second pixel 2212, and the third pixel 2213 and the brightness of the B sub-pixels B7, B8, and B9 included in the seventh pixel 2217, the eighth pixel 2218, the ninth pixel 2219.

In summary, the brightness of the sub-pixels R4, G4, B4, R5, G5, B5, R6, G6, and B6 included in the fourth pixel 2214, the fifth pixel 2215, and the sixth pixel 2216 may have a value between the brightness of the sub-pixels R1, G1, B1, R2, G2, B2, R3, G3, and B3 included in the first pixel 2211, the second pixel 2212, and the third pixel 2213 the brightness of the sub-pixels R7, G7, B7, R8, G8, B8, R9, G9, and B9 included in the seventh pixel 2217, the eighth pixel 2218 and the ninth pixel 2219.

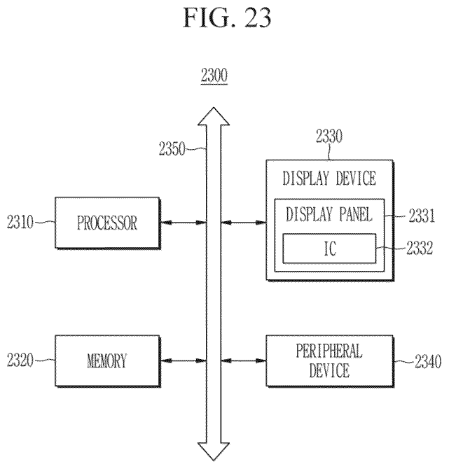

FIG. 23 is a diagram illustrating a display system according to one or more embodiments.

Referring to FIG. 23, the display system 2300 according to one or more embodiments may include a processor 2310, a memory 2320, a display device 2330, and a peripheral device 2340 electrically connected to the system bus 2350.

The processor 2310 may control input/output of data of the memory 2320, the display device 2330, and the peripheral device 2340, and may perform image processing of image data transmitted between corresponding devices.

The memory 2320 may include a volatile memory such as a dynamic random access memory DRAM and/or a nonvolatile memory such as a flash memory. The memory 2320 may include a DRAM, a phase-change random access memory PRAM, a magnetic random-access memory MRAM, a resistive random access memory ReRAM, a ferroelectric random access memory FRAM, a NOR flash memory, a NAND flash memory, and a fusion flash memory (for example, a memory that combines a static random access memory SRAM buffer with NAND flash memory and NOR interface logic). The memory 2320 may store image data acquired from the peripheral device 2340 or an image signal processed by the processor 2310.

The display device 2330 includes a display panel 2331, and the display panel 2331 may include an interpolation circuit 2332.

The interpolation circuit 2332 receive a plurality of data signals from a source driver of the present disclosure and may provide a data signal obtained by interpolating a first data signal corresponding to a first source line among the plurality of source lines and a second data signal corresponding to a second source line among the plurality of source lines to a third source line between the first source line and the second source line.

The peripheral device 2340 may be a device that converts a video into an electrical signal such as a camera, a scanner, a webcam, or a still image. The image data acquired through the peripheral device 2340 may be stored in the memory 2320 or may be displayed on the panel 2331 in real time.

The display system 2300 may be provided in a mobile electronic product such as a smartphone, but is not limited thereto, and may be provided in various types of electronic products displaying an image.

Although the embodiments of the present disclosure have been described in detail above, the scope of the present disclosure is not limited thereto, and various modifications and improvements of those skilled in the art using the basic concept of the present disclosure defined in the following claims also belong to the scope of the present disclosure.

In some embodiments, each component or combination of two or more components described with reference to FIG. 1 to FIG. 23 may be implemented as a digital circuit, a programmable or unprogrammable logic device or array, an application specific integrated circuit ASIC, or the like.

Although the embodiments of the present disclosure have been described in detail above, the scope of the present disclosure is not limited thereto, and various modifications and improvements of those skilled in the art using the basic concept of the present disclosure defined in the following claims also belong to the scope of the present disclosure.

What is claimed is:

1. A display device comprising:
a pixel array comprising:
a plurality of pixels;
a plurality of gate lines; and
a plurality of source lines connected to the plurality of pixels;
a gate driver configured to apply a plurality of gate signals to each of the plurality of gate lines;
a source driver configured to generate a plurality of first data signals corresponding to each of the plurality of source lines; and
an interpolation circuit configured to:
receive the plurality of first data signals from the source driver; and
provide a second data signal, obtained by interpolating a first data signal corresponding to a first source line among the plurality of source lines and a first data signal corresponding to a third source line among the plurality of source lines, to a second source line between the first source line and the third source line.

2. The display device of claim 1, wherein the interpolation circuit comprises:
a first resistor connected between the first source line and the second source line;
a first switch connected between the first source line and the first resistor;
a second switch connected between the second source line and the first resistor;
a second resistor connected between the second source line and the third source line;
a third switch connected between the second source line and the second resistor; and
a fourth switch connected between the third source line and the second resistor.

3. The display device of claim 2, wherein the interpolation circuit comprises:
a plurality of first resistors connected in parallel between the first source line and the second source line;
a plurality of first switches respectively connected between each of the plurality of first resistors and the first source line;
a plurality of second switches respectively connected between each of the plurality of first resistors and the second source line;
a plurality of second resistors connected in parallel between the second source line and the third source line;
a plurality of third switches respectively connected between each of the plurality of second resistors and the second source line; and
a plurality of fourth switches respectively connected between each of the plurality of second resistors and the third source line.

4. The display device of claim 2 further comprising:
a timing controller configured to receive an image signal, comprising a first area rendered with a first quality and a second area rendered with a second quality lower than the first quality, from a host device.

5. The display device of claim 4, wherein the timing controller is further configured to:
receive area indication data, indicating a first display area displaying the first area and a second display area displaying the second area, from the host device; and
generate a switching control signal for controlling the first switch, the second switch, the third switch, and the fourth switch based on the area indication data.

6. The display device of claim 5, wherein the timing controller is further configured to:
generate the switch control signal for controlling the first switch, the second switch, the third switch, and the fourth switch to open when pixels connected to each of the first source line, the second source line, and the third source line are in the first display area, based on the area indication data.

7. The display device of claim 5, wherein the timing controller is further configured to:
generate the switch control signal for controlling the first switch, the second switch, the third switch, and the fourth switch to close when pixels connected to each of the first source line, the second source line, and the third source line are in the second display area, based on the area indication data.

8. The display device of claim 7,
wherein the source driver comprises a plurality of source amplifiers respectively connected to each of the first source line, the second source line, and the third source line, and
wherein the timing controller is further configured to generate a source amplifier control signal for turning off a second source amplifier connected to the second source line, among the plurality of source amplifiers.

9. The display device of claim 8, wherein the source driver further comprises:
a plurality of first amplifier switches, each respectively connected to an output terminal of each of the plurality of source amplifiers;
a plurality of second amplifier switches, each respectively connected between an inverting terminal of each of the plurality of source amplifiers and each of the plurality of first amplifier switches; and
a plurality of third amplifier switches, each respectively connected to the inverting terminal of each of the plurality of source amplifiers and each of the first source line, the second source line, and the third source line.

10. The display device of claim 8,
wherein the first source line, the second source line, and the third source line are respectively connected to a plurality of sub-pixels in one pixel through a multiplexer, and
wherein the multiplexer is configured to receive the second data signal from the interpolation circuit and provide the second data signal to only one sub-pixel among the plurality of sub-pixels.

11. The display device of claim 10, wherein the plurality of sub-pixels have different colors.

12. The display device of claim 1, further comprising:
a plurality of the second source lines including the second source line,
wherein the interpolation circuit is further configured to provide a plurality of the second data signal, obtained by interpolating the first data signal corresponding to the first source line and the first data signal corresponding to the third source line, to the plurality of second source lines.

13. The display device of claim 12, wherein the interpolation circuit comprises:
a first resistor connected between one of the plurality of second source lines and the first source line;
a first switch connected between the first source line and the first resistor;
a second switch connected between one of the plurality of second source lines and the first resistor;
at least one second resistor connected between a first adjacent second source line and a second adjacent second source line among the plurality of second source lines;
a third switch connected between the first adjacent second source line and the at least one second resistor;
a fourth switch connected between the second adjacent second source line and the at least one second resistor;
a third resistor connected between another one of the plurality of second source lines and the third source line;
a fifth switch connected between the other one of the plurality of second source lines and the third resistor; and
a sixth switch connected between the third source line and the third resistor.

14. A display system comprising:
a host device providing an image signal comprising a first area rendered with a first quality and a second area rendered with a second quality lower than the first quality; and
a display device comprising a plurality of pixels and a plurality of source lines respectively connected to the plurality of pixels, the display device being configured to:
generate a plurality of first data signals by the image signal; and
provide second data signals, obtained by interpolating the plurality of first data signals, to source lines among the plurality of source lines connected to pixels among the plurality of pixels that are displaying the second area.

15. The display system of claim 14 further comprising an eye tracking sensor configured to:
track a position of a user eye to obtain eye tracking data; and
transmit the eye tracking data to the host device.

16. The display system of claim 15, wherein the host device further comprises an image processor configured to:
render the first area corresponding to the position of the user eye with the first quality; and
render the second area which is a peripheral area of the first area with the second quality based on the eye tracking data.

17. The display system of claim 14,
wherein the host device is further configured to transmit a driving control signal comprising area indication data indicating the first area and the second area to the display device according to the image signal, and
wherein the display device is further configured to generate a gate driver control signal, a source driver control signal, and a switch control signal based on the driving control signal.

18. The display system of claim 17, wherein the display device further comprises:
a switch controller configured to:
receive the switch control signal from the host device; and
generate a switch signal for differently driving a plurality of switches connecting between source lines among the plurality of source lines connected to pixels among the plurality of pixels displaying the first area, and a plurality of switches connecting between source lines among the plurality of source lines connected to pixels among the plurality of pixels displaying the second area.

19. A method of driving a display device comprising:
turning off a source amplifier that outputs a data signal to a source line connected to a pixel during a first period in which the pixel displays an area rendered with a first quality;
turning on the source amplifier during a second period before the pixel displays an area rendered with a second quality higher than the first quality; and
outputting the data signal for the source amplifier to the source line connected to the pixel during a third period in which the pixel displays the area rendered with the second quality.

20. The method of claim 19, wherein turning off the source amplifier during the first period comprises receiving a switch signal that causes a first switch connected between an output terminal of the source amplifier and the source line, a second switch connected to a first signal line connected between an inverting terminal of the source amplifier and the first switch, and a third switch connected to the inverting terminal of the source amplifier and a second signal line connected to the source line, to open a switch from a switch controller, and
wherein turning on the source amplifier during the second period comprises:
receiving the switch signal for the first switch and the third switch to open the switch from the switch controller;
receiving the switch signal for the second switch to close the switch from the switch controller;
outputting the data signal for the source amplifier to the source line connected to the pixel during the third period;
receiving the switch signal for the first switch and the third switch to close the switch from the switch controller; and
receiving the switch signal for the second switch to open the switch from the switch controller.
